(19) United States
(12) Patent Application Publication
(10) Pub. No.: US 2025/0251109 A1
(43) Pub. Date: Aug. 7, 2025

(54) LIGHT-EMITTING MODULE AND VEHICLE LAMP COMPRISING SAME

(71) Applicant: SL Corporation, Daegu (KR)

(72) Inventors: Sungwook YOUN, Gyeongsan-si (KR); Youngho SON, Gyeongsan-si (KR); Jongseok LEE, Gyeongsan-si (KR)

(21) Appl. No.: 19/044,217

(22) Filed: Feb. 3, 2025

Related U.S. Application Data
(63) Continuation of application No. PCT/KR2023/019302, filed on Nov. 28, 2023.

(30) Foreign Application Priority Data
Dec. 14, 2022 (KR) 10-2022-0174789
Jul. 14, 2023 (KR) 10-2023-0091440
Nov. 24, 2023 (KR) 10-2023-0165336

(51) Int. Cl. F21S 43/20; F21S 41/64; F21W 103/35; F21W 103/55

(52) U.S. Cl. CPC F21S 43/26241; F21S 41/64; F21W 2103/35; F21W 2103/55

(57) ABSTRACT

A light-emitting module capable of implementing surface light emission includes a substrate which is formed of a transparent material; at least one light source which is provided at a rear surface of the substrate to emit light in a first direction; and a deflection part which is disposed at the rear of the substrate and by which the light emitted in the first direction is deflected in a second direction. In particular, the deflection part includes a reflective layer formed on at least a portion of the surface of a holder, opposite to the substrate, the holder being arranged at the rear of the substrate to support the substrate; and a reflective surface formed on at least a portion of the rear surface of a transmissive material arranged between the substrate and the holder.

### CROSS-REFERENCE TO RELATED APPLICATIONS

This application is a Continuation of International Application No. PCT/KR2023/019302 filed Nov. 28, 2023, which claims priority from Korean Application No. 10-2022-0174789 filed Dec. 14, 2022, Korean Application No. 10-2023-0091440 filed Jul. 14, 2023, and Korean Application No. 10-2023-0165336 filed Nov. 24, 2023. The aforementioned applications are incorporated herein by reference in their entireties.

### TECHNICAL FIELD

The present disclosure relates to a light-emitting module and a vehicle lamp comprising the same and more specifically, to a light-emitting module capable of implementing surface light emission and a vehicle lamp comprising the same.

### RELATED ART

Generally, vehicles are equipped with various types of lamps that serve both an illumination function, which allows the driver to easily identify objects near the vehicle during low-light conditions (e.g., nighttime driving), and a signaling function, which informs other drivers or pedestrians of the vehicle's operating status.

For example, headlamps and fog lamps are primarily intended for illumination purposes, while turn signal lamps, tail lamps, and brake lamps are primarily intended for signaling purposes. Each lamp is regulated by laws regarding installation criteria and specifications to fully exhibit its intended function.

In terms of functionality and design, surface light emission is occasionally required for vehicle lamps, and to achieve this, light emitted from multiple light sources is mixed to implement surface light emission.

When surface light emission is implemented by mixing light from multiple light sources, a gap of sufficient length for adequate light mixing is necessary. However, this gap limits the ability to reduce the overall size of the vehicle lamp.

Furthermore, when surface light emission is implemented by mixing light from multiple light sources, the areas near each light source exhibit relatively higher brightness. As a result, the regions corresponding to each light source may have higher brightness compared to other regions, leading to a decrease in the overall brightness uniformity of the surface light emission.

Therefore, there is a need for a solution that enables surface light emission using multiple light sources while reducing the overall size of the lamp and improving the uniformity of brightness.

### SUMMARY

An objective of the present disclosure is to provide a light-emitting module and a vehicle lamp comprising the same, which allow for miniaturization by shortening the gap required for light mixing.

Another objective is to provide a light-emitting module and a vehicle lamp comprising the same, which improve overall brightness uniformity of surface light emission by diffusing the light generated from light sources.

The objectives of the present disclosure are not limited to those mentioned above, and other objectives not explicitly stated will be clearly understood by those skilled in the art based on the following description.

To achieve the above-described objectives, a light-emitting module according to an embodiment of the present disclosure may include a substrate formed of a transparent material; at least one light source installed on a rear surface of the substrate to emit light in a first direction; and a deflection part disposed behind the substrate to deflect the light, which is emitted in the first direction, in a second direction. In particular, the deflection part may include a reflective surface formed on at least a portion of a rear surface of a transmissive material disposed between the substrate and a holder that is disposed behind the substrate to support the substrate.

The deflection part may further include at least one diffusion element formed on the rear surface of the transmissive material to diffuse the light emitted in the first direction so that at least a portion of the light is deflected in the second direction via refraction and/or reflection. The rear surface of the transmissive material may include a first region where the at least one diffusion element is formed and a second region where no diffusion element is formed, and the reflective surface may be formed in at least one of the first region or the second region.

The reflective surface may be formed by depositing or coating a material capable of reflecting light. Alternative or additionally, the reflective surface may be formed by applying a color capable of reflecting light.

The deflection part may further include a reflective layer formed on at least a portion of an opposing surface of the holder that faces the substrate.

The light-emitting module may further include at least one light diffusion layer disposed to overlap with the at least one light source to diffuse light that passes near the at least one light source. The at least one light diffusion layer may transmit a portion of the deflected light therethrough while reflecting another portion of the deflected light. The at least one light diffusion layer may be formed to have a greater thickness proximate to a center of the at least one light source. Alternatively or additionally, the at least one light diffusion layer may be formed by stacking a plurality of layers, and an upper layer, which is disposed in a stacking direction of the plurality of layers, may be formed to have a smaller dimension in at least one direction relative to a center of the at least one light source. The at least one light diffusion layer may be formed on one surface of at least one of the substrate or a cover disposed in front of the substrate to allow at least a portion of the light deflected by the deflection part to pass therethrough.

The light-emitting module may further include a cover disposed in front of the substrate to allow at least a portion of the light deflected by the deflection part to pass therethrough, the cover having at least one optical element formed at a position corresponding to the at least one light source to deflect the light that passes through the substrate.

To achieve the above-described objectives, a vehicle lamp may include a light-emitting module including at least one light source; and a diffusion lens disposed in front of the light-emitting module to diffuse light emitted from the light-emitting module. In particular, a direction in which the light is emitted from the light-emitting module may be different from a direction in which the light is emitted from the at least one light source.

The light-emitting module may include: a substrate having the at least one light source installed on a rear surface thereof; a holder disposed behind the substrate to support the substrate; a transmissive material disposed between the substrate and the holder; and a cover disposed in front of the substrate and coupled to the holder to form a space for accommodating the substrate and the transmissive material therein. The cover may include at least one optical element formed at a position corresponding to the at least one light source to deflect at least a portion of the light transmitted through the substrate.

The transmissive material may include at least one diffusion element formed on a rear surface of the transmissive material to deflect the light emitted in a first direction from the at least one light source in a second direction, and a reflective surface may be formed on at least a portion of the rear surface of the transmissive material to reflect at least a portion of the light emitted in the first direction from the at least one light source.

The at least one diffusion element may refract and/or reflect at least a portion of the light emitted in the first direction in the second direction depending on an angle of incidence of the light emitted in the first direction.

The light-emitting module of the vehicle lamp may further include a reflective layer formed on at least a portion of an opposing surface of the holder that faces the substrate.

The vehicle lamp may further include at least one light diffusion layer disposed to overlap with the at least one light source, and the at least one light diffusion layer may reflect a portion of light that passes near the at least one light source and transmits another portion of the light therethrough. The at least one light diffusion layer may be formed to have a greater thickness proximate to a center of the at least one light source. Additionally or alternatively, the at least one light diffusion layer may include a plurality of stacked layers, and an upper layer, which is disposed in a stacking direction of the plurality of layers, may be formed to have a smaller dimension in at least one direction relative to a center of the at least one light source.

Other specific details of the present disclosure are included in the detailed description and drawings.

The light-emitting module and the vehicle lamp comprising the same according to the present disclosure as described above can achieve one or more of the following effects.

Light emitted in a first direction from light sources installed at the rear surface of the substrate may be deflected in a second direction by the deflection part, and at least some of the light deflected by the deflection part may proceed forward after passing through the cover disposed in front of the substrate. Consequently, the gap required for light mixing can be relatively shortened, making it advantageous for miniaturization and improving the uniformity of brightness when implementing surface light emission.

In addition, the brightness uniformity of the surface light emission can be improved by a light diffusion layer disposed to overlap the light sources, and dark shadow regions potentially caused by the rear surfaces of the light sources can be improved when viewed from the front due to the deflection of light passing through the substrate by the optical elements formed by the cover.

The effects of the present disclosure are not limited to those mentioned above, and other effects not explicitly stated will be clearly understood by those skilled in the art.

### BRIEF DESCRIPTION OF THE DRAWINGS

FIG. 1 is a perspective view illustrating a light-emitting module according to a first embodiment of the present disclosure.

FIG. 2 is a side view illustrating the light-emitting module according to the first embodiment of the present disclosure.

FIGS. 3 and 4 are exploded perspective views illustrating a first light-emitting module according to an embodiment of the present disclosure.

FIG. 5 is a cross-sectional view taken along line A-A′ of FIG. 1.

FIG. 6 is a schematic view illustrating the gap required for light mixing according to the first embodiment of the present disclosure.

FIG. 7 is a schematic view illustrating the installation intervals of light sources according to the first embodiment of the present disclosure.

FIG. 8 is a cross-sectional view illustrating a diffusion sheet according to the first embodiment of the present disclosure.

FIGS. 9 and 10 are cross-sectional views illustrating a phosphor sheet according to the first embodiment of the present disclosure.

FIG. 11 is an exploded perspective view illustrating a light-emitting module according to a second embodiment of the present disclosure.

FIG. 12 is a cross-sectional view illustrating the light-emitting module according to the second embodiment of the present disclosure.

FIG. 13 is a cross-sectional view illustrating a first diffusion element according to the second embodiment of the present disclosure.

FIGS. 14 through 19 are schematic views illustrating light paths by the first diffusion element of FIG. 13.

FIG. 20 is a cross-sectional view illustrating a second diffusion element according to the second embodiment of the present disclosure.

FIGS. 21 through 24 are schematic views illustrating light paths by the second diffusion element of FIG. 20.

FIG. 25 is a cross-sectional view illustrating the first diffusion element and the second diffusion element according to the second embodiment of the present disclosure.

FIG. 26 is a perspective view illustrating a light-emitting module according to a third embodiment of the present disclosure.

FIG. 27 is a cross-sectional view illustrating the light-emitting module according to the third embodiment of the present disclosure.

FIG. 28 is a schematic view illustrating the light path of the light-emitting module according to the third embodiment of the present disclosure.

FIG. 29 is an exploded perspective view illustrating a second diffusion pattern with a partition wall shape according to the third embodiment of the present disclosure.

FIG. 30 is an exploded perspective view illustrating a light-emitting module according to a fourth embodiment of the present disclosure.

FIG. 31 is a cross-sectional view illustrating the light-emitting module according to the fourth embodiment of the present disclosure.

FIG. 32 is an exploded perspective view illustrating a light-emitting module according to a fifth embodiment of the present disclosure.

FIG. 33 is a cross-sectional view illustrating the light-emitting module according to the fifth embodiment of the present disclosure.

FIG. 34 is a cross-sectional view illustrating a light-emitting module according to a sixth embodiment of the present disclosure.

FIG. 35 is an exploded perspective view illustrating a light-emitting module according to a seventh embodiment of the present disclosure.

FIG. 36 is a cross-sectional view illustrating the light-emitting module according to the seventh embodiment of the present disclosure.

FIG. 37 is a schematic view illustrating light paths of a light diffusion layer according to the seventh embodiment of the present disclosure.

FIGS. 38 and 39 are schematic views illustrating the structure of the light diffusion layer according to the seventh embodiment of the present disclosure.

FIG. 40 is a perspective view illustrating a light-emitting module according to an eighth embodiment of the present disclosure.

FIG. 41 is a cross-sectional view taken along line B-B′ of FIG. 40.

FIG. 42 is a schematic view illustrating the light paths by the optical elements according to the eighth embodiment of the present disclosure.

FIG. 43 is a schematic view illustrating a line along which the brightness of the light-emitting module according to the embodiments of the present disclosure is measured.

FIG. 44 schematically illustrates the brightness distribution of a light-emitting module according to an embodiment of the present disclosure.

FIG. 45 schematically illustrates the manufacturing process of a light-emitting module according to an embodiment of the present disclosure.

FIGS. 46 and 47 are perspective views illustrating substrates with apertures formed according to embodiments of the present disclosure.

FIG. 48 is a cross-sectional view illustrating a substrate with apertures formed according to an embodiment of the present disclosure.

FIG. 49 is a perspective view illustrating a vehicle lamp according to an embodiment of the present disclosure.

FIG. 50 is a side view illustrating the vehicle lamp according to an embodiment of the present disclosure.

### DETAILED DESCRIPTION

The advantages and features of the present disclosure, as well as methods for achieving them, will become apparent with reference to the embodiments described in detail below and the accompanying drawings. However, the present disclosure is not limited to the embodiments disclosed below and may be implemented in various forms. The embodiments are provided only to ensure the completeness of the present disclosure and to fully convey the scope of the disclosure to those skilled in the art. The present disclosure is defined solely by the scope of the claims. Throughout the specification, the same reference numerals indicate the same components.

Therefore, in some embodiments, well-known process steps, structures, and techniques are not specifically described to prevent the present disclosure from being ambiguously interpreted.

The terms used in this specification are for describing embodiments and are not intended to limit the present disclosure. In this specification, the singular form includes the plural form unless otherwise specified. The terms “comprises” and/or “comprising,” as used in the specification, do not exclude the presence or addition of one or more other components, steps, actions, and/or elements not explicitly mentioned. Additionally, “and/or” includes each of the listed items and any combination of one or more of the listed items.

Furthermore, the embodiments described in this specification will be explained with reference to cross-sectional and/or schematic views that are ideal examples of the present disclosure. Therefore, variations in the forms illustrated in the exemplary drawings may occur due to manufacturing techniques and/or tolerances. Accordingly, the embodiments of the present disclosure are not limited to the specific forms illustrated and also include variations in form created during manufacturing processes. Moreover, each component in the drawings of the present disclosure may be depicted slightly enlarged or reduced for convenience of explanation. Throughout the specification, the same reference numerals indicate the same components.

The present disclosure will hereinafter be described with reference to the drawings to explain light-emitting modules and vehicle lamps comprising the same according to embodiments of the present disclosure. Features of each embodiment may be interchanged or combined.

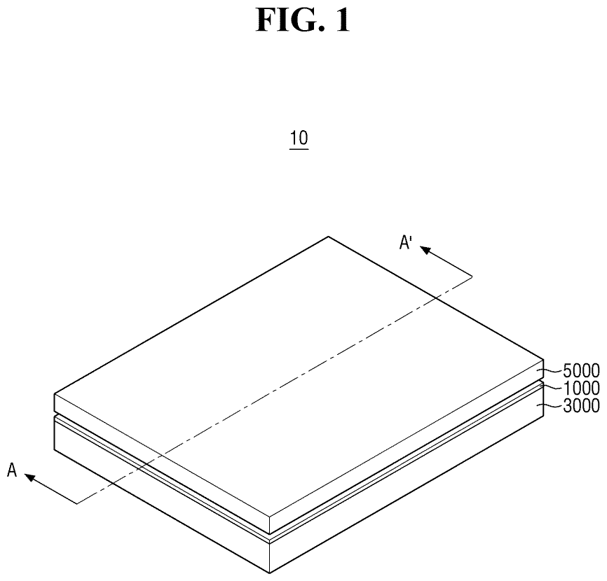

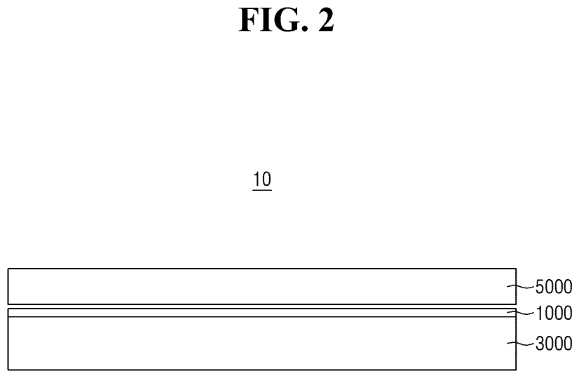

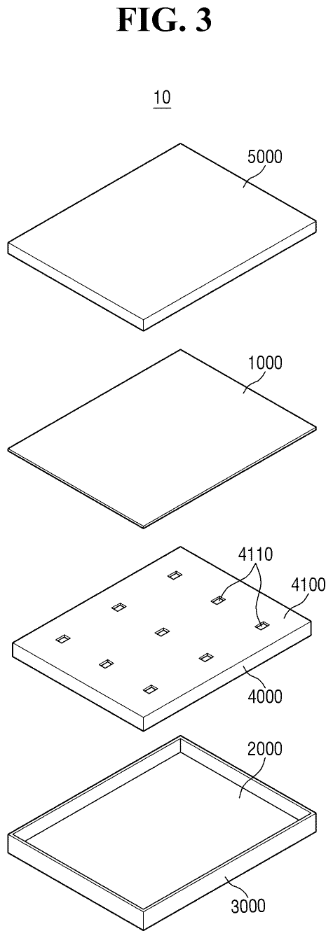

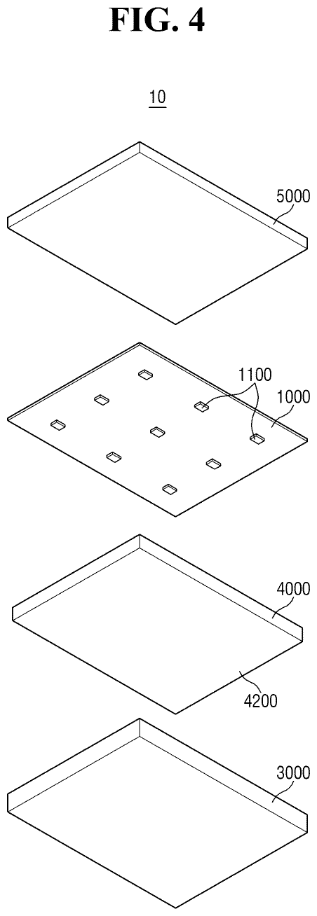

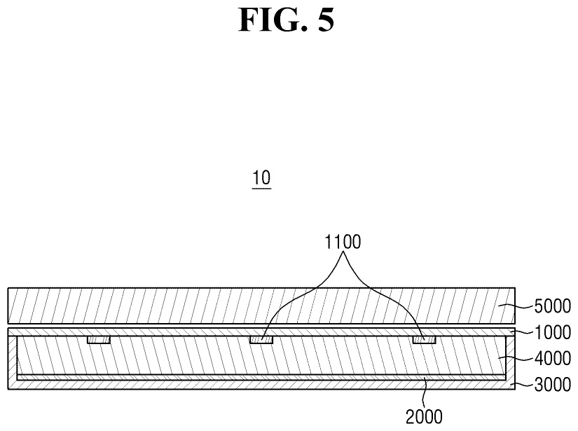

FIG. 1 is a perspective view illustrating a light-emitting module according to a first embodiment of the present disclosure, FIG. 2 is a side view illustrating the light-emitting module according to the first embodiment of the present disclosure, FIGS. 3 and 4 are exploded perspective views illustrating a first light-emitting module according to an embodiment of the present disclosure, and FIG. 5 is a cross-sectional view taken along line A-A′ of FIG. 1.

Referring to FIGS. 1 through 5, a light-emitting module 10 according to the first embodiment of the present disclosure may include a substrate 1000 and a deflection part 2000.

In the first embodiment of the present disclosure, the light-emitting module 10 may be installed in, for example, a vehicle such as an automobile or train, to secure nighttime visibility or to inform surrounding vehicles or pedestrians of the driving status of the vehicle. However, the light-emitting module 10 of the present disclosure is not limited thereto and may be installed not only in means of transportation such as a vehicle, but also in any location requiring surface light emission.

The substrate 1000 may have at least one light source (hereinafter referred to as “the first light source”) 1100 installed on its rear surface. In the first embodiment of the present disclosure, at least one first light source 1100 may include a plurality of first light sources 1100 spaced apart at predetermined intervals to prevent structural interference.

At this time, the front surface of the substrate 1000 may be understood as the surface facing forward, which is the direction in which light is emitted from the light-emitting module 10 of the present disclosure. In this case, the plurality of first light sources 1100 may be understood to be installed on the rear surface of the substrate 1000, which is not visible when viewed from the front of the light-emitting module 10 of the present disclosure.

The deflection part 2000 may function to deflect light emitted in a first direction from the plurality of first light sources 1100 into a second direction through refraction and/or reflection. In the first embodiment of the present disclosure, the deflection part 2000 may be disposed at a predetermined distance from the rear of the substrate 1000 to reflect the light emitted in the first direction from the plurality of first light sources 1100 and allow it to be deflected into the second direction.

In embodiments of the present disclosure, the first direction refers to the direction from the substrate 1000 toward the deflection part 2000, and the second direction refers to one or more directions different from the first direction. In the first embodiment of the present disclosure, the description that the deflection part 2000 that reflects the light emitted in the first direction and allows it to be deflected into the second direction may be understood as reflecting the light emitted from the plurality of first light sources 1100 to be deflected into one or more directions different from the first direction.

The substrate 1000 may allow at least a portion of the light reflected/deflected into the second direction by the deflection part 2000 to pass therethrough, such that the light may be emitted externally from the light-emitting module 10 of the present disclosure. As a result, surface light emission can be implemented by the light-emitting module 10 of the present disclosure.

Here, the light emitted in the first direction from the plurality of first light sources 1100 may travel a first distance between the substrate 1000 and the deflection part 2000, and the light deflected into the second direction by the deflection part 2000 may travel a second distance between the substrate 1000 and the deflection part 2000. Since at least a portion of this light passes through the substrate 1000 and is emitted externally from the light-emitting module 10 of the present disclosure, the light path can become relatively longer as the light travels back and forth between the substrate 1000 and the deflection part 2000. Consequently, the space (i.e., the gap) required for light mixing can be relatively shortened, which is advantageous for miniaturization.

In other words, when the plurality of first light sources 1100 are installed on the front surface of the substrate 1000, the light emitted from the plurality of first light sources 1100 proceeds forward, requiring a sufficient gap length in a single direction, i.e., in front of the substrate 1000, for proper light mixing. In contrast, in the first embodiment of the present disclosure, the light emitted in the first direction from the plurality of first light sources 1100 installed on the rear surface of the substrate 1000 is reflected and deflected into the second direction by the deflection part 2000 disposed behind the substrate 1000. As a result, the light paths can overlap between the substrate 1000 and the deflection part 2000, enabling the gap required for light mixing to be shortened.

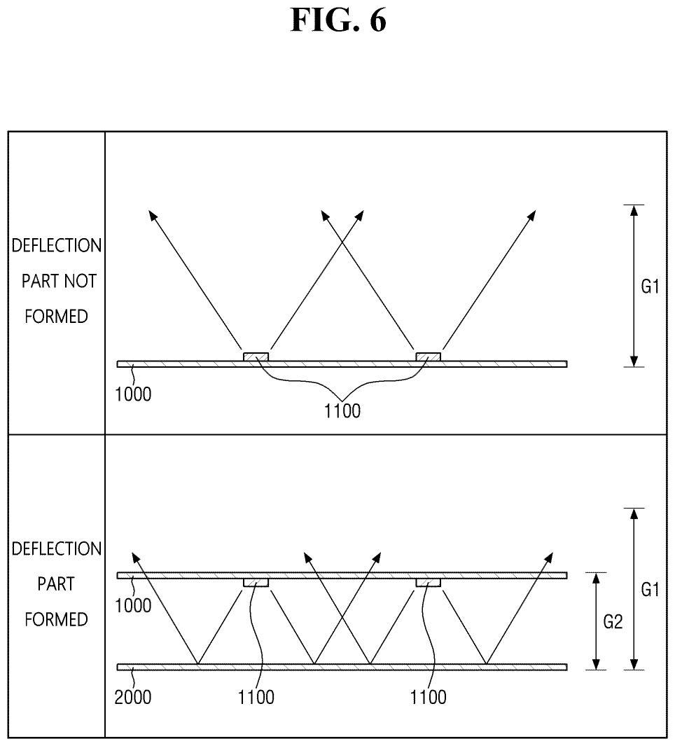

For example, as illustrated in FIG. 6, when the plurality of first light sources 1100 are installed on the front surface of the substrate 1000 and emit light forward, without the deflection part 2000, the gap G1 required for sufficient light mixing in front of the substrate 1000 becomes relatively longer. In contrast, in the first embodiment of the present disclosure, the light emitted in the first direction from the plurality of first light sources 1100 installed on the rear surface of the substrate 1000 is reflected and deflected in the second direction by the deflection part 2000 disposed behind the substrate 1000. As a result, the gap G2 required for sufficient light mixing can have a length approximately less than half of what is required when the plurality of first light sources 1100 are installed on the front surface of the substrate 1000.

In this manner, when the light emitted from the plurality of first light sources 1100 travels the first distance and the second distance before being emitted externally from the light-emitting module 10 of the present disclosure, the thickness of the light-emitting module 10 of the present disclosure can be reduced compared to the total length of the light path of the light emitted from the plurality of first light sources 1100, facilitating miniaturization.

In other words, the thickness of the light-emitting module 10 of the present disclosure in the front-rear direction may vary depending on the gap required for light mixing of the light emitted from the plurality of first light sources 1100. When the plurality of first light sources 1100 are installed on the front surface of the substrate 1000, the light-emitting module 10 of the present disclosure is required to have a thickness corresponding to the total length of the light path of light emitted from the plurality of first light sources 1100. In contrast, in this embodiment of the present disclosure, since the light emitted from the plurality of first light sources 1100 travels back and forth between the substrate 1000 and the deflection part 2000 before being emitted externally, the light-emitting module 10 of the present disclosure can have a thickness smaller than the total length of the light path of the light emitted from the plurality of first light sources 1100.

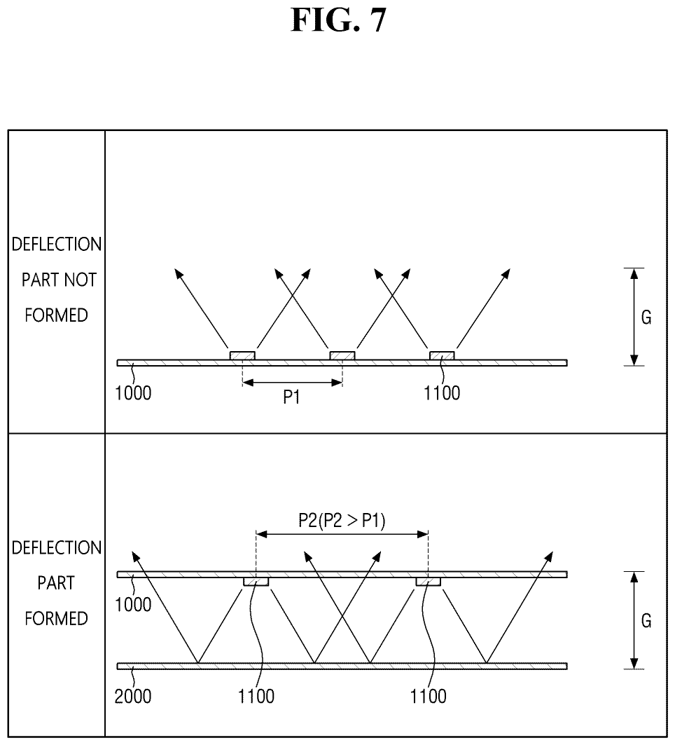

Furthermore, as illustrated in FIG. 7, when the gaps G provided for light mixing are equal, the installation interval (e.g., separation distance) P2 between the plurality of first light sources 1100 installed on the rear surface of the substrate 1000 may become greater than the installation interval P1 of the plurality of first light sources 1100 installed on the front surface of the substrate 1000, since the light emitted in the first direction from the plurality of first light sources 1100 installed on the rear surface of the substrate 1000 is allowed to travel back and forth between the substrate 1000 and the deflection part 2000 for improved mixing (e.g., diffusion). Consequently, the required number of light sources decreases, thereby reducing the number of components and costs.

In the first embodiment of the present disclosure, the substrate 1000 may be implemented as a transparent PCB formed of a material such as polyester (PET) or transparent polyimide (CPI) that allows light to pass through, enabling the light reflected and deflected into the second direction by the deflection part 2000 to pass through the substrate 1000 and be emitted externally. However, this is merely exemplary for aiding understanding the present disclosure and not limiting. Alternatively, the substrate 1000 may be implemented as an opaque PCB, with at least a portion of the opaque PCB opened to allow the light deflected into the second direction by the deflection part 2000 to pass through the substrate 1000 and be emitted externally. A detailed description of the case where the substrate 1000 is implemented as the opaque PCB will be provided later.

The deflection part 2000 may be formed on at least a portion of the opposing surface of a holder 3000 that faces the substrate 1000, which is disposed behind the substrate 1000 to support the substrate 1000. In some embodiments, between the substrate 1000 and the deflection part 2000, a transmissive material 4000 formed of a light-transmissive material may be filled. The transmissive material 4000 may allow the light that travels between the substrate 1000 and the deflection part 2000 to undergo total internal reflection, thereby preventing light loss due to leakage. Additionally, the transmissive material 4000 may include a diffusion material that aids light diffusion. A detailed description of the method of forming the transmissive material 4000 will be provided later.

At this time, the holder 3000 may be formed with one side open to accommodate the substrate 1000, the deflection part 2000, and the transmissive material 4000. A cover 5000 may be assembled onto the open side of the holder 3000, forming a receiving space to house the substrate 1000, the deflection part 2000, and the transmissive material 4000 therein. The light that proceeds forward after passing through the substrate 1000 may pass through the cover 5000 and be emitted externally. The light that passes through the cover 5000 may be understood as the light emitted externally from the light-emitting module 10 of the present disclosure.

In the first embodiment of the present disclosure, the deflection part 2000 may be formed by depositing or coating a material with high reflectivity, such as aluminum or chromium, onto at least a portion of the opposing surface of the holder 3000 that faces the substrate 1000, or by applying a paint with a high-reflectivity color, such as white. However, the present disclosure is not limited thereto. The deflection part 2000 may also be formed as a separate film and attached to at least a portion of the opposing surface of the holder 3000 that faces the substrate 1000.

The transmissive material 4000 may include a plurality of receiving grooves 4110 on a front surface 4100 thereof to accommodate the plurality of first light sources 1100. A rear surface 4200 of the transmissive material 4000 may abut the deflection part 2000. As the plurality of first light sources 1100 are accommodated in the plurality of receiving grooves 4110, the substrate 1000 and the transmissive material 4000 may be disposed in close contact with each other.

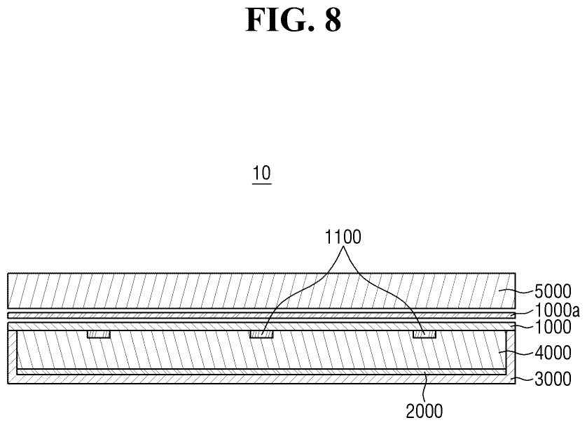

Meanwhile, in some embodiments, to diffuse the light that is reflected by the deflection part 2000 and passes through the substrate 1000, a diffusion sheet 1000a may be disposed in front of the substrate 1000, as illustrated in FIG. 8. The diffusion sheet 1000a may improve the overall brightness uniformity when implementing surface light emission through the light-emitting module 10 of the present disclosure.

In the first embodiment of the present disclosure, an example is described where a diffusion material is added to the transmissive material 4000, but the present disclosure is not limited thereto. A diffusion material may also be added to other components that allow light to pass through, such as the substrate 1000, the diffusion sheet 1000a, and the cover 5000.

At this time, FIG. 8 illustrates an example where the diffusion sheet 1000a is disposed in front of the substrate 1000, but the present disclosure is not limited thereto. The diffusion sheet 1000a may be disposed on at least one of the front or rear sides of the substrate 1000.

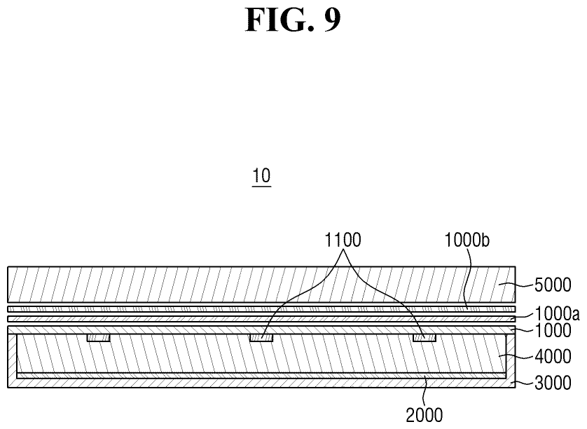

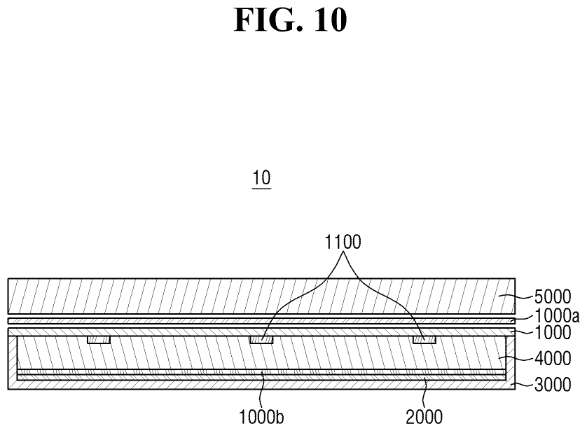

Additionally, the plurality of first light sources 1100 may emit light of a specific color, or to emit excitation light suitable for exciting a phosphor. When the light emitted from the plurality of first light sources 1100 functions as excitation light, a phosphor sheet 1000b that contains a phosphor may be disposed in front of the substrate 1000, as illustrated in FIG. 9, or in front of the deflection part 2000, as illustrated in FIG. 10.

FIG. 9 illustrates an example where the phosphor sheet 1000b is disposed in front of the diffusion sheet 1000a, which is disposed in front of the substrate 1000. FIG. 10 illustrates an example where the phosphor sheet 1000b is disposed in front of the deflection part 2000. However, the present disclosure is not limited thereto, and the phosphor sheet 1000b may also be disposed behind the substrate 1000 or behind the deflection part 2000.

Additionally, FIGS. 9 and 10 illustrate examples where the diffusion sheet 1000a is disposed in front of the substrate 1000. However, if sufficient diffusion of light is ensured, the diffusion sheet 1000a may be omitted.

In the first embodiment of the present disclosure, an example is described where a transmissive phosphor, which emits fluorescent light in response to illumination of excitation light through the opposite side of the incident surface receiving the excitation light, is used. However, the present disclosure is not limited thereto. Depending on the position of the phosphor sheet 1000b, a reflective phosphor, which emits fluorescent light through the surface receiving the excitation light, may also be used.

The phosphor sheet 1000b described above may function to convert first light having a first wavelength range, which is emitted from the plurality of first light sources 1100, into second light having a second wavelength range.

In this case, the phosphor sheet 1000b may include a phosphor material that generates the second light in the second wavelength range, or may include a phosphor material that, when excited by the first light, generates third light in a third wavelength range. If the phosphor sheet 1000b includes a phosphor material that generates the third light, the second light may be understood as a mixture with a predetermined mixing ratio of the first light transmitted through the phosphor sheet 1000b and the third light generated by the phosphor material.

Generating the second light, where the first light and third light are mixed by the phosphor sheet 1000b, may prevent excessive phosphor content from acting as a factor that interferes with light transmission by ensuring that the phosphor material is contained at an appropriate level. Excessive phosphor content may adversely affect the efficiency of the phosphor sheet 1000b. Such a phosphor sheet 1000b is disclosed in U.S. Patent Publication No. 2023/0060919 A1, which is incorporated herein by reference in its entirety.

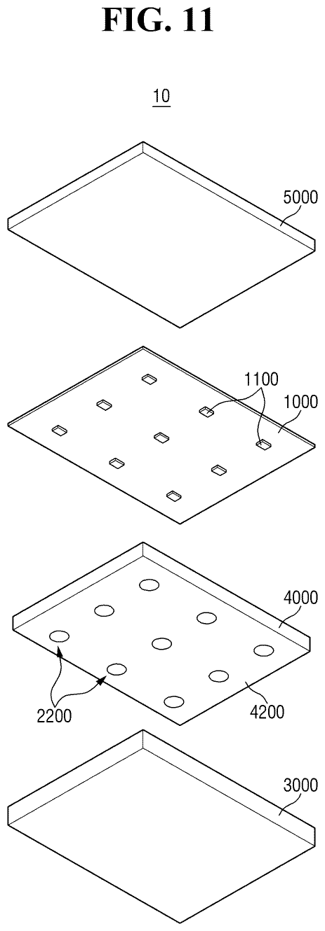

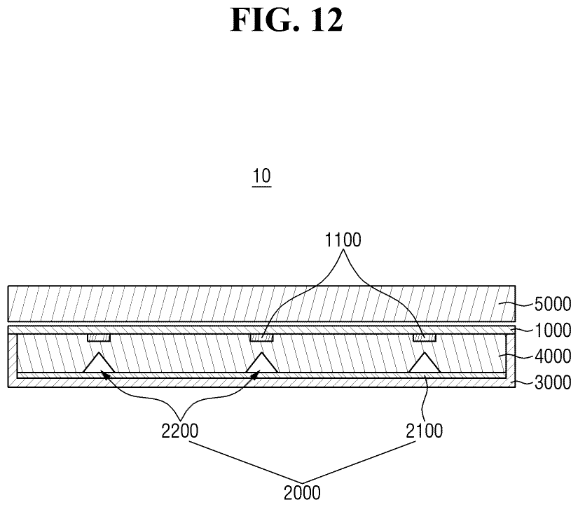

FIG. 11 is an exploded perspective view illustrating a light-emitting module according to a second embodiment of the present disclosure, and FIG. 12 is a cross-sectional view illustrating the light-emitting module according to the second embodiment of the present disclosure.

Referring to FIGS. 11 and 12, a light-emitting module 10 according to the second embodiment of the present disclosure, like its counterpart of the previous embodiment, may include a substrate 1000 and a deflection part 2000. Components performing the same roles as in the previous embodiment are denoted by the same reference numerals, and detailed descriptions of their roles will be omitted.

In the second embodiment of the present disclosure, the deflection part 2000 may include a reflective layer 2100 formed on at least a portion of the opposing surface of a holder 3000 that faces the substrate 1000, and a plurality of diffusion elements 2200 formed to recess on a rear surface 4200 of a transmissive material 4000 to deflect the light emitted in a first direction from a plurality of first light sources 1100 into a second direction.

In other words, in the second embodiment of the present disclosure, the deflection part 2000 may consist of the reflective layer 2100 and the plurality of diffusion elements 2200, whereas, in the first embodiment, the deflection part 2000 is understood as consisting only of the reflective layer 2100, with the plurality of diffusion elements 2200 omitted.

The plurality of diffusion elements 2200 may function to refract or reflect light based on the incident angle of light emitted in the first direction from the plurality of first light sources 1100, thereby diffusing the light.

In the second embodiment of the present disclosure, the deflection of light into the second direction by the plurality of diffusion elements 2200 may be understood as refracting or reflecting light depending on its incident angle into one or more directions different from the first direction.

In the second embodiment of the present disclosure, an example is described where the plurality of diffusion elements 2200 corresponding to the plurality of first light sources 1100 are formed at predetermined intervals on the rear surface 4200 of the transmissive material 4000, but the present disclosure is not limited thereto. Alternatively, one diffusion element may correspond to two or more of the plurality of first light sources 1100, or vice versa.

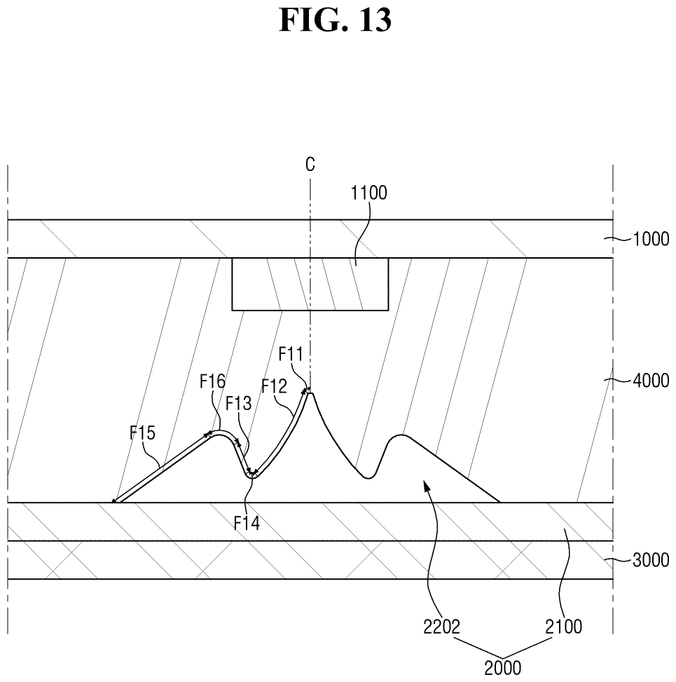

FIG. 13 is a cross-sectional view illustrating a first diffusion element of the second embodiment of the present disclosure. FIG. 13 illustrates an example where the first diffusion element corresponds to one of the plurality of first light sources 1100.

Referring to FIG. 13, a diffusion element (hereinafter referred to as “the first diffusion element”) 2202 of the second embodiment of the present disclosure may be formed to be axisymmetric about a central axis C of a first light source 1100. The central axis C may be understood as an axis that vertically passes through the center of the light-emitting surface of the first light source 1100.

The first diffusion element 2202 may include a plurality of surfaces F11 through F16 formed at different radial positions with respect to the central axis C. Each of the plurality of surfaces F11 through F16 may be understood as an interface between the interior and exterior of the transmissive material 4000. Each of the plurality of surfaces F11 through F16 may function to diffuse light through at least one of refraction or reflection.

In the second embodiment of the present disclosure, the first diffusion element 2202 may include first through sixth surfaces F11 through F16. The roles of each of the first through sixth surfaces F11 through F16 are as follows.

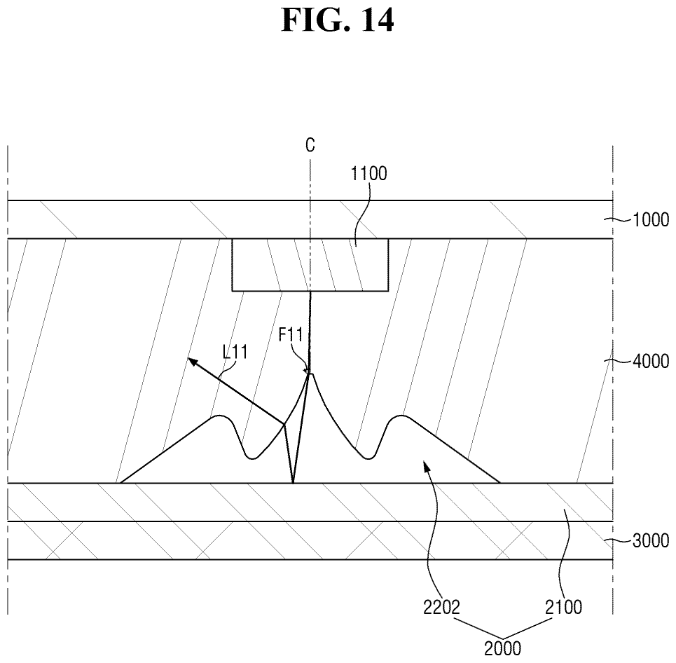

The first surface F11 may be centered on the central axis C and may function to refract first light L11, incident from the first light source 1100, to proceed in a direction away from the central axis C, as illustrated in FIG. 14. The first light L11 refracted by the first surface F11 may be reflected by the reflective layer 2100 toward the substrate 1000 and then refracted by the second surface F12 in a direction away from the central axis C.

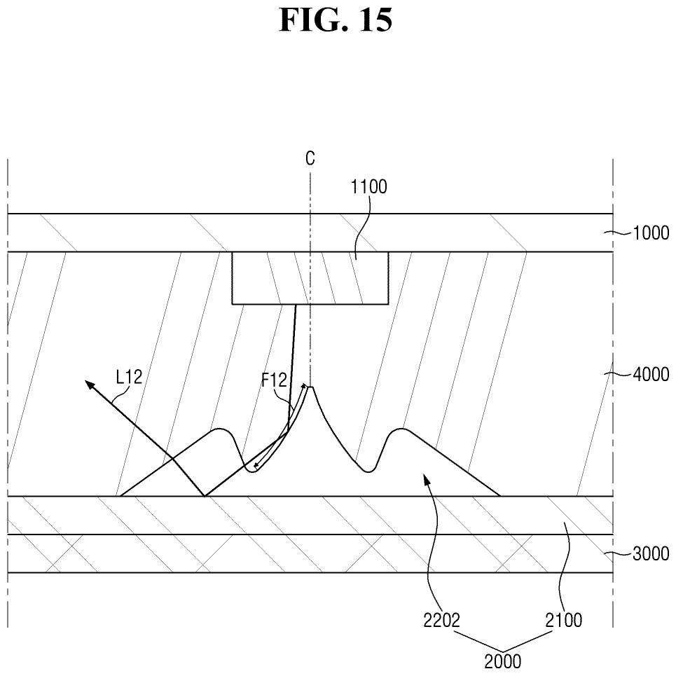

The second surface F12 may extend away from the substrate 1000, starting from a first end connected to the edge of the first surface F11 to a second end along the direction of the central axis C, and may be formed with the second end disposed radially farther from the central axis C than the first end. As illustrated in FIG. 15, the second surface F12 may reflect the second light L12, incident from the first light source 1100, to proceed in a direction away from the central axis C. Additionally, as illustrated in FIG. 14, the second surface F12 may function to refract the first light L11 refracted by the first surface F11 in a direction away from the central axis C.

The third surface F13 may be disposed radially outward from the central axis C compared to the second surface F12, and may be formed to extend along the direction of the central axis C, with a first end close to the first light source 1100 disposed radially farther from the central axis C than a second end distant from the first light source 1100.

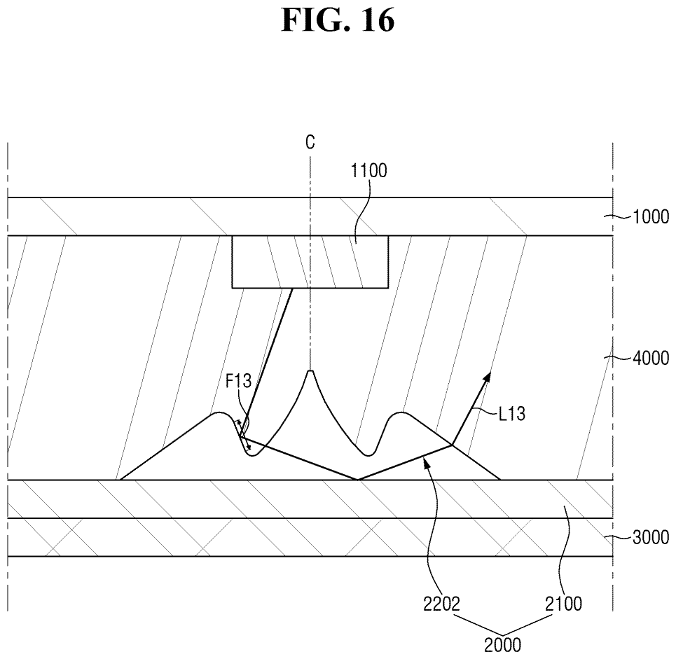

As illustrated in FIG. 16, the third surface F13 may function to reflect the third light L13, generated from the first light source 1100, to proceed past the central axis C and then in a direction away from the central axis C.

The fourth surface F14 may be formed concavely with respect to the first light source 1100 to connect the second end of the second surface F12 to the second end of the third surface F13. The fourth surface F14 may function to prevent light from proceeding in an undesired direction at the boundary between the second and third surfaces F12 and F13.

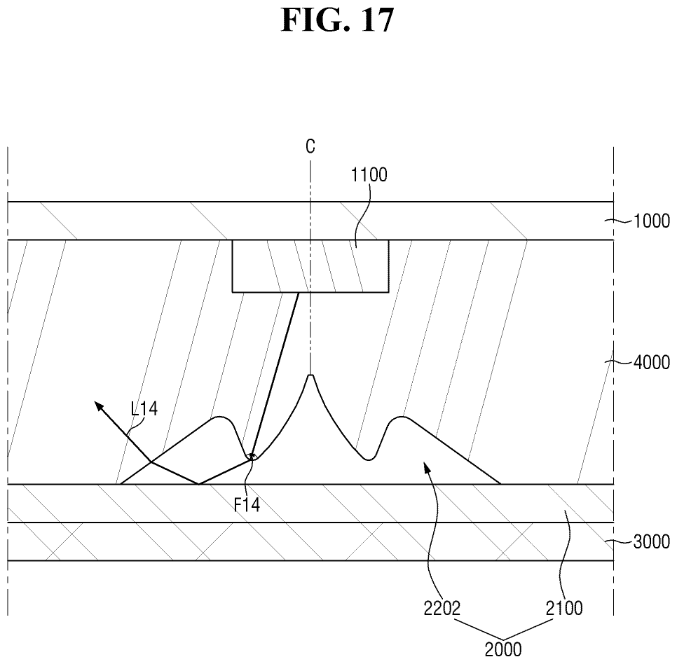

In other words, if the second and third surfaces F12 and F13 are directly connected to form an angle, light may proceed in an unintended direction at the boundary between the second and third surfaces F12 and F13. Thus, the fourth surface F14 is designed to be curved with a predetermined curvature, as illustrated in FIG. 17, to refract fourth light L14, incident at the boundary between the second and third surfaces F12 and F13, in a direction away from the central axis C.

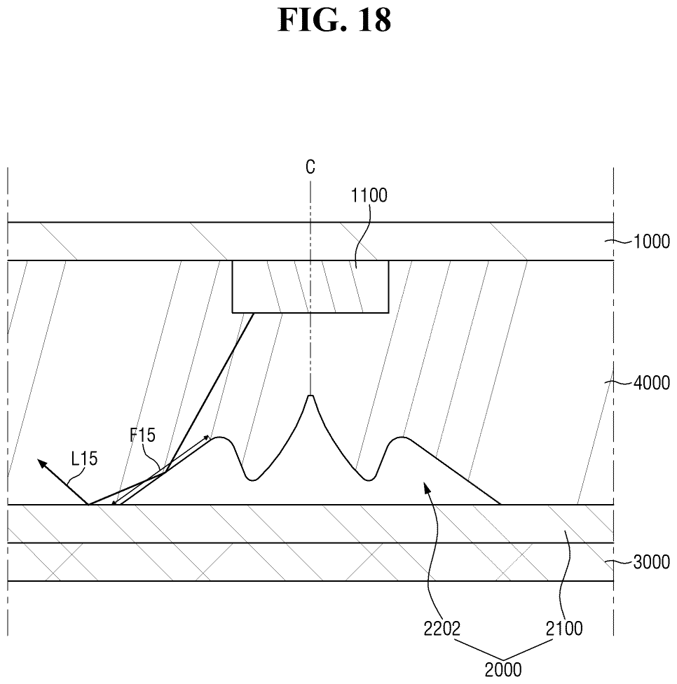

The fifth surface F15 may be formed to extend along the direction of the central axis C, with a first end close to the light source 110 disposed radially farther from the central axis C than a second end distant from the light source 110. As illustrated in FIG. 18, the fifth surface F15 may function to reflect fifth light L15, incident from the first light source 1100, to proceed in a direction away from the central axis C.

At this time, the second end of the fifth surface F15 may be disposed on the rear surface 4200 of the transmissive material 4000. An aperture of the first diffusion element 2202 on the rear surface 4200 of the transmissive material 4000 may be formed by the second end of the fifth surface F15 to have a diameter that ensures that no hotspots are caused by the first light source 1100.

In other words, if the aperture diameter of the first diffusion element 2202 is too small, the light emitted from the first light source 1100 may not be sufficiently diffused before being reflected forward by the reflective layer 2100. In this case, hotspots may occur, where the brightness of light near the first light source 1100 is relatively higher than the surrounding brightness. To prevent such an issue, the position of the second end of the fifth surface F15 may be determined so that the aperture diameter of the first diffusion element 2202 may be large enough to avoid hotspots.

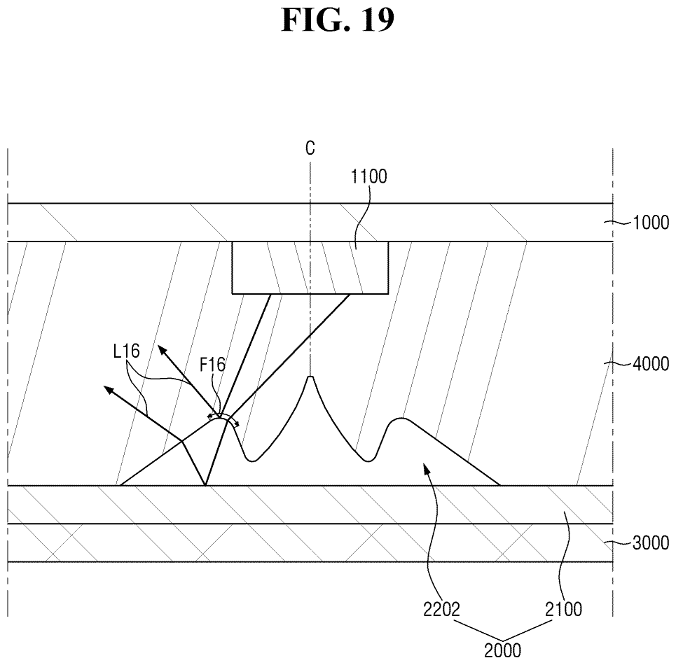

The sixth surface F16 may be formed convexly with respect to the first light source 1100 to connect the first end of the third surface F13 to the first end of the fifth surface F15. The sixth surface F16 may be disposed farther from the first light source 1100 in the direction of the central axis C compared to the first surface F11. As illustrated in FIG. 19, the sixth surface F16 may be designed to be curved with a predetermined curvature to ensure that sixth light L16, incident from the first light source 1100, does not proceed in an unintended direction. Thus, the sixth surface F16 may function to diffuse the sixth light L16 by refraction or reflection.

As described above, the first diffusion element 2202 may be formed in an overall conical shape. Thus, when the light emitted from the first light source 1100 is diffused through refraction or reflection by the first diffusion element 2202, enabling the implementation of surface emission by the light-emitting module 10 of the present disclosure, the light emitted from the light-emitting module 10 of the present disclosure can generally have more uniform brightness.

Additionally, in embodiments of the present disclosure, the cases of refracting (or transmitting) light, reflecting light, and refracting and reflecting light via the first through sixth surfaces F11 through F16 of the first diffusion element 2202 are described separately. However, this is merely exemplary for aiding understanding of the present disclosure and is not limiting. Alternatively, each of the first through sixth surfaces F11 through F16 of the first diffusion element 2202 may be configured to refract or reflect light emitted from the first light source 1100, depending on the angle of incidence.

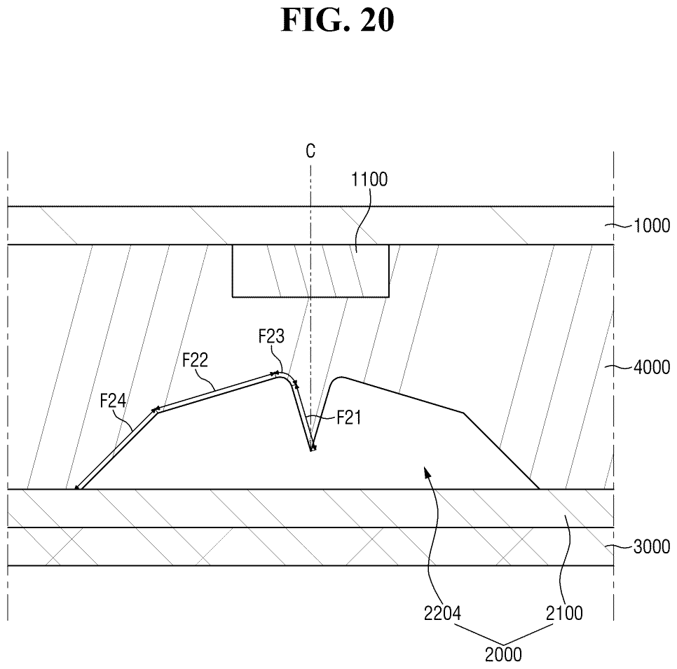

FIG. 20 is a schematic view illustrating a second diffusion element according to the second embodiment of the present disclosure, specifically, an exemplary second diffusion element corresponding to one of the plurality of first light sources 1100.

Referring to FIG. 20, a diffusion element (hereinafter referred to as “the second diffusion element”) 2204 according to the second embodiment of the present disclosure may be formed to be axisymmetric about the central axis C of the first light source 1100, similar to the first diffusion element 2202 of FIG. 13 described above. The second diffusion element 2204 may function to diffuse light emitted from the first light source 1100, thereby enabling surface light emission.

The second diffusion element 2204 may include a plurality of surfaces F21 through F24 formed at different radial positions with respect to the central axis C of the first light source 1100. Each of the plurality of surface F21 through F24 may function to diffuse light emitted from the first light source 1100 through refraction, reflection, or both.

The second diffusion element 2204 may include first through fourth surfaces F21 through F24. The detailed roles of the first through fourth surfaces F21 through F24 are as follows.

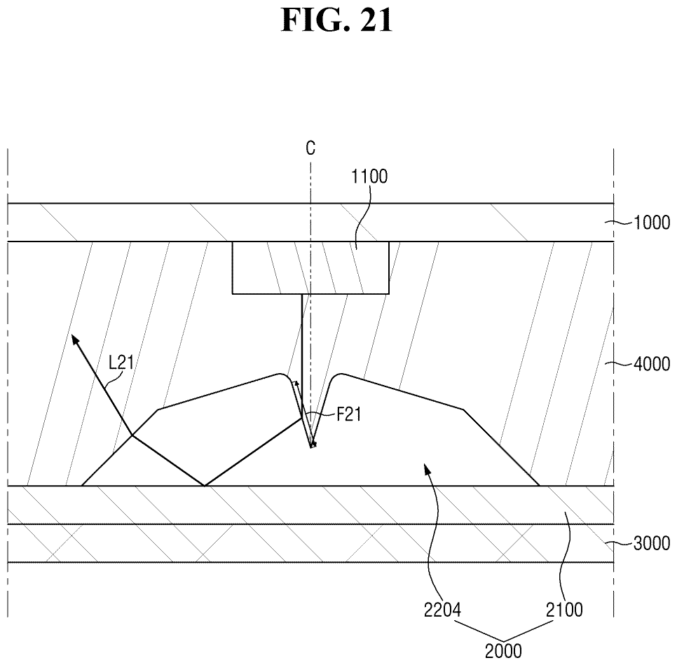

The first surface F21 may be formed to extend along the central axis C, with a first end close to the first light source 1100 disposed radially farther from the central axis C than a second end on the central axis C. As illustrated in FIG. 21, the first surface F21 may function to refract first light L21, emitted from the first light source 1100, to proceed in a direction away from the central axis C.

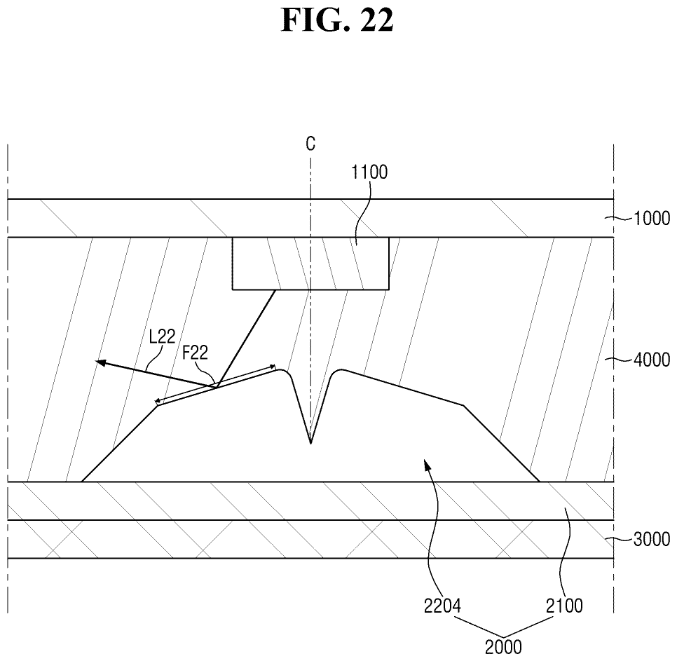

The second surface F22 may be disposed farther radially outward from the central axis C compared to the first surface F21, and may be formed along the direction of the central axis C, with a first end close to the first light source 1100 disposed radially more proximate to the central axis C than a second end distant from the first light source 1100. The second surface F22 may function to reflect the second light L22 emitted from the first light source 1100 to proceed in a direction away from the central axis C, as illustrated in FIG. 22.

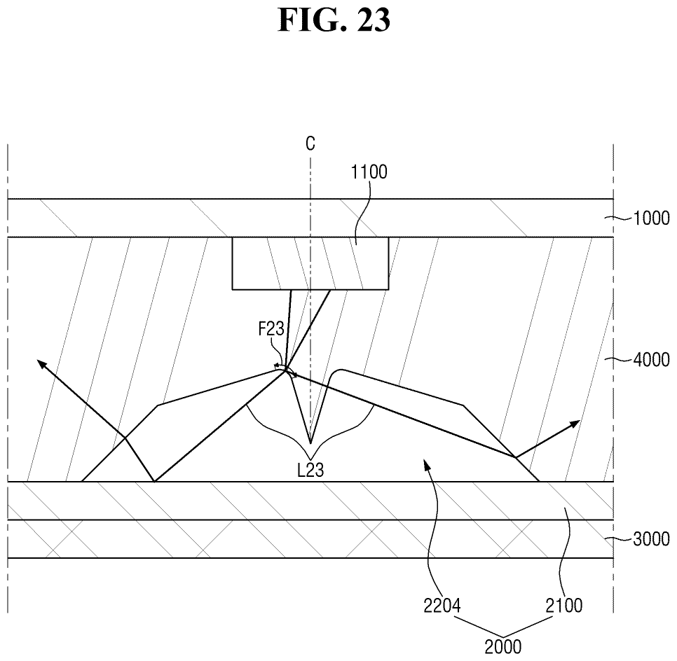

The third surface F23 may be formed with a predetermined curvature between the first ends of the first and second surfaces F21 and F22. Thus, as illustrated in FIG. 23, the third surface F23 may function to reflect or refract third light L23, incident near the boundary between the first ends of the first and second surfaces F21 and F22, thereby diffusing the light.

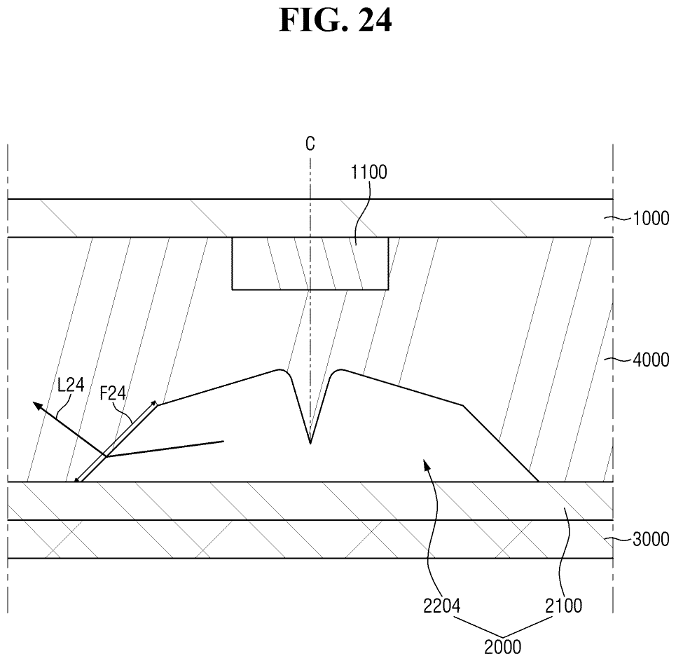

The fourth surface F24 may be formed along the central axis C with a first end linked to the second end of the second surface F22 and a second end connected to the rear surface 4200 of the transmissive material 4000. The fourth surface F24 may be formed with the second end disposed radially farther from the central axis C than the first end. Thus, as illustrated in FIG. 24, the fourth surface F24 may function to refract fourth light L24, incident from the cavity into the transmissive material 4000, to proceed in a direction away from the central axis C.

Meanwhile, as illustrated in FIGS. 21 and 23, the fourth surface F24 may function to refract the first light L21 refracted by the first surface F21 and the third light L23 refracted by the third surface F23 to proceed in a direction away from the central axis C when these lights are reflected forward by the reflective layer 2100.

As described above, the second diffusion element 2204 may be formed in an overall dome shape. When surface light emission is implemented by the light-emitting module 10 of the present disclosure, the second diffusion element 2204 may diffuse the light emitted from the first light source 1100 through at least one of refraction or reflection, ensuring that the light emitted externally from the light-emitting module 10 has an improved uniformity. Thus, when the light emitted from the first light source 1100 is diffused through refraction or reflection by the first diffusion element 2202, enabling the implementation of surface emission by the light-emitting module 10 of the present disclosure, the light emitted from the light-emitting module 10 of the present disclosure can generally have more uniform brightness.

Additionally, in the second embodiment of the present disclosure, the cases of refracting (or transmitting) light, reflecting light, and refracting and reflecting light via the first through fourth surfaces F21 through F24 of the second diffusion element 2204 are described separately. However, this is merely exemplary for aiding understanding of the present disclosure and is not limiting. Each of the first through fourth surfaces F21 through F24 of the second diffusion element 2204 may be configured to refract or reflect light emitted from the first light source 1100, depending on the angle of incidence.

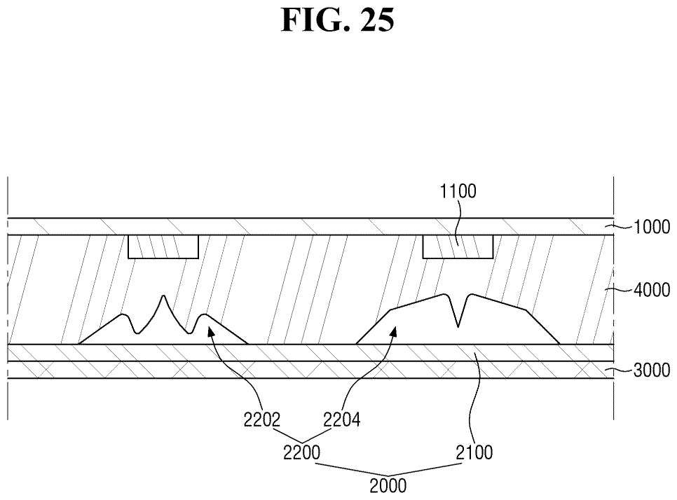

In the second embodiment described above, the first and second diffusion elements 2202 and 2204 are described as separate diffusion elements 2200. However, this is merely exemplary for aiding understanding of the present disclosure and is not exclusive of mixing different types of diffusion elements. As illustrated in FIG. 25, the first and second diffusion elements 2202 and 2204 may be mutually included as the diffusion elements 2200 in the same embodiment.

Meanwhile, when a plurality of diffusion elements 2200 are formed on the rear surface of the transmissive material 4000, each of the plurality of diffusion elements 2200 may refract or reflect light emitted not only from its corresponding first light source 1100 but also from adjacent or other light sources, ensuring that the light emitted from the adjacent light sources is also diffused, depending on the angle of incidence.

In the following embodiments of the present disclosure, an example is provided where the deflection part 2000 includes the reflective layer 2100 and the plurality of diffusion elements 2200. However, this is merely exemplary for aiding understanding of the present disclosure and is not limiting. The deflection part 2000 may include the reflective layer 2100 and/or the plurality of diffusion elements 2200.

In the second embodiment described above, an example is provided where a plurality of diffusion elements 2200 corresponding to the plurality of first light sources 1100, respectively, are formed, but the present disclosure is not limited thereto. Alternatively or additionally, the plurality of diffusion elements 2200 may be disposed not only at positions corresponding to the plurality of first light sources 1100, but also between adjacent first light sources among the plurality of first light sources 1100.

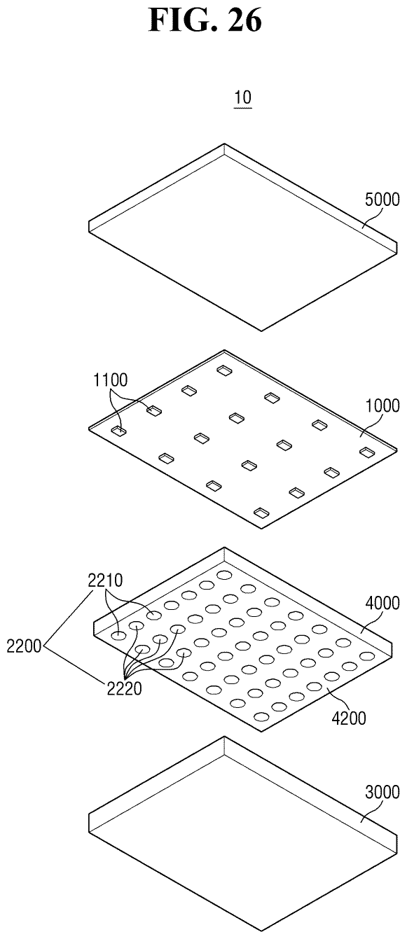

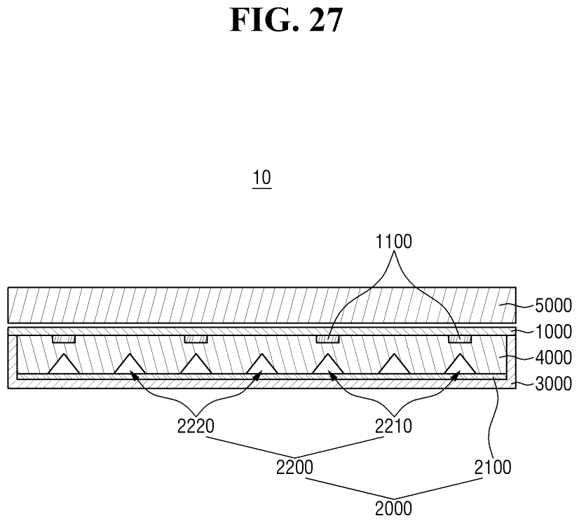

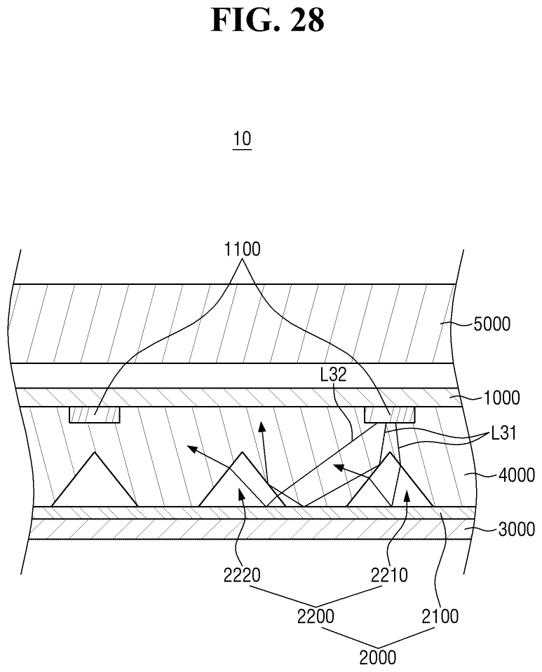

FIG. 26 is a perspective view illustrating a light-emitting module according to a third embodiment of the present disclosure, FIG. 27 is a cross-sectional view illustrating the light-emitting module according to the third embodiment of the present disclosure, and FIG. 28 is a schematic view illustrating the light path of the light-emitting module according to the third embodiment of the present disclosure.

Referring to FIGS. 26 through 28, a light-emitting module 10 according to the third embodiment of the present disclosure, like its counterparts of the previous embodiments, may include a substrate 1000 and a deflection part 2000. Components performing the same functions as those in the previous embodiments are assigned the same reference numerals, and detailed descriptions thereof will be omitted.

In the third embodiment of the present disclosure, a plurality of diffusion elements 2200 may include a plurality of first diffusion patterns 2210 corresponding to a plurality of first light sources 1100 and a plurality of second diffusion patterns 2220 formed between adjacent first diffusion patterns 2210 among the plurality of first diffusion patterns 2210.

Each of the plurality of first diffusion patterns 2210 may be configured to refract or reflect light L31 emitted in the first direction from the corresponding first light source among the plurality of first light sources 1100, depending on the angle of incidence. Each of the plurality of second diffusion patterns 2220 may be formed between adjacent first diffusion patterns 2210 and may diffuse light L32, which deviates from the corresponding first diffusion pattern among the plurality of first light sources 1100, through refraction and/or reflection. Additionally, light refracted or reflected by the plurality of first diffusion patterns 2210 may be further refracted and/or reflected by the plurality of second diffusion patterns 2220, thereby improving diffusion efficiency and mitigating dark shadow regions, which may occur between adjacent first light sources among the plurality of first light sources 1100.

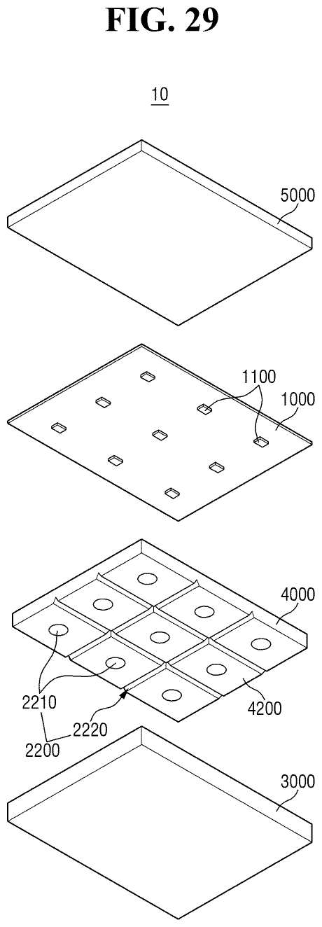

In the third embodiment of the present disclosure, an example is described where the plurality of second diffusion patterns 2220 are disposed at predetermined intervals, similar to the plurality of first diffusion patterns 2210. Alternatively, as illustrated in FIG. 29, the plurality of second diffusion patterns 2220 may also be formed in a partition wall shape, which is elongated in at least one direction between adjacent first diffusion patterns.

Meanwhile, in the third embodiment of the present disclosure, an example is described where the plurality of second diffusion patterns 2220 improve the dark shadow regions that may occur between the plurality of first light sources 1100. However, the present disclosure is not limited thereto, and the light-emitting module 10 of the present disclosure may also function to enable two or more functions simultaneously.

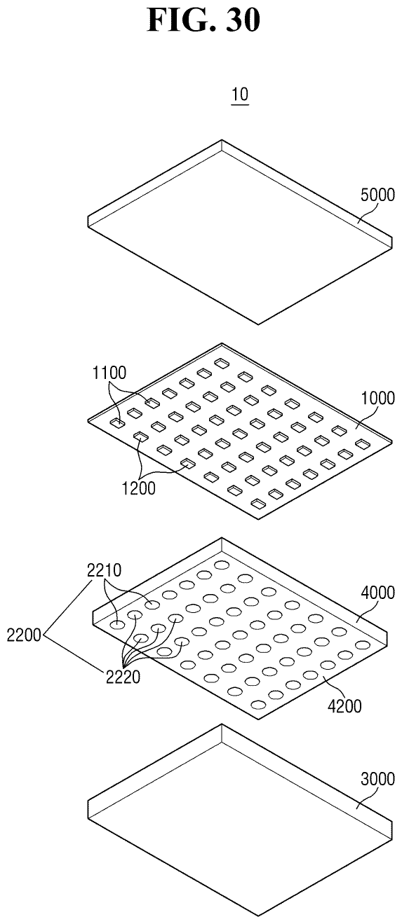

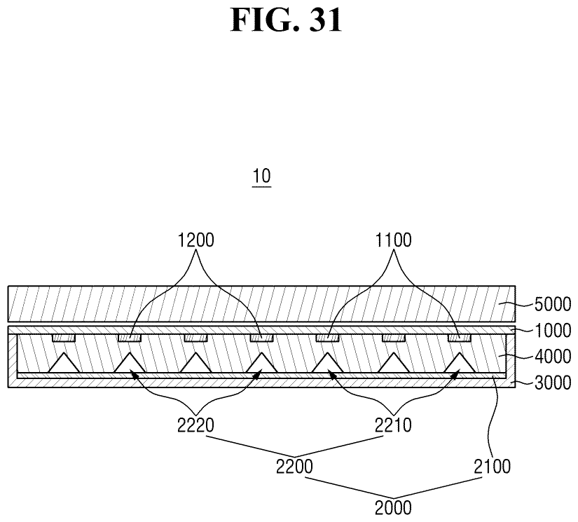

FIG. 30 is an exploded perspective view illustrating a light-emitting module according to a fourth embodiment of the present disclosure, and FIG. 31 is a cross-sectional view illustrating the light-emitting module according to the fourth embodiment of the present disclosure.

Referring to FIGS. 30 and 31, a light-emitting module 10 according to the fourth embodiment of the present disclosure, like its counterparts of the previous embodiments, may include a substrate 1000 and a deflection part 2000. Components performing the same functions as those in the previous embodiments are assigned the same reference numerals, and detailed descriptions thereof will be omitted.

In the fourth embodiment of the present disclosure, not only a plurality of first light sources 1100 but also a plurality of light sources (hereinafter referred to as “the second light sources”) 1200 disposed between adjacent first light sources among the plurality of first light sources 1100 may be installed on the rear surface of a substrate 1000. The plurality of first light sources 1100 and the plurality of second light sources 1200 may be alternately arranged in at least one direction. A plurality of first diffusion patterns 2210 may be formed to correspond to the plurality of first light sources 1100, and a plurality of second diffusion patterns 2220 may be formed to correspond to the plurality of second light sources 1200.

The installation of the plurality of second light sources 1200 on the rear surface of the substrate 1000, as well as the plurality of first light sources 1100, may allow the light-emitting module 10 of the present disclosure to be used for different functions simultaneously.

For example, in case the plurality of first light sources 1100 are configured to emit white light and the plurality of second light sources 1200 are configured to emit amber light, the light-emitting module 10 of the present disclosure may function as a daytime running lamp (DRL) when the plurality of first light sources 1100 are lit, and as a turn signal lamp when the plurality of second light sources 1200 are lit.

Additionally, in a case where the plurality of first light sources 1100 are configured to emit red light and the plurality of second light sources 1200 are configured to emit amber light, the light-emitting module 10 of the present disclosure may function as a brake lamp when the plurality of first light sources 1100 are lit, and as a turn signal lamp when the plurality of second light sources 1200 are lit.

In the fourth embodiment of the present disclosure, an example is described where either the plurality of first light sources 1100 or the plurality of second light sources 1200 are lit while the other set of light sources are turned off, depending on the function of the light-emitting module 10. However, the present disclosure is not limited thereto, and the plurality of first light sources 1100 and the plurality of second light sources 1200 may also be lit simultaneously. In some embodiments, the intensity of light emitted from each light source may be controlled such that the color of the resulting light from mixing the light emitted from the plurality of first light sources 1100 and the plurality of second light sources 1200 enables the implementation of a wider variety of colors, allowing the light-emitting module 10 to serve more diverse functions.

At this time, in the fourth embodiment of the present disclosure, an example is described where the light-emitting module 10 generates light in two colors using the plurality of first light sources 1100 and the plurality of second light sources 1200. However, this is merely exemplary for aiding understanding of the present disclosure and is not limiting. Alternatively, the substrate 1000 may be configured with light sources that generate three or more different colors of light.

In the following embodiments of the present disclosure, an example is provided where the plurality of first light sources 1100 are installed on the substrate 1000. However, the present disclosure is not limited to this, and may also be applied similarly in cases where both the plurality of first light sources 1100 and the plurality of second light sources 1200 are installed on the substrate 1000.

In the aforementioned embodiments of the present disclosure, an example is provided where the light refracted or reflected by the plurality of diffusion elements 2200 formed on the rear surface 4200 of the transmissive material 4000 is reflected in the second direction by the reflective layer 2100 formed on at least a portion of the opposing surface of the holder 3000 that faces the substrate 1000. However, the present disclosure is not limited thereto. Alternatively, at least some regions of the rear surface 4200 of the transmissive material 4000 may be coated or deposited with a high-reflectivity material such as aluminum or chromium, or painted with a high-reflectivity color such as white, so that at least some of the light emitted in the first direction from the plurality of first light sources 1100 may be deflected to the second direction.

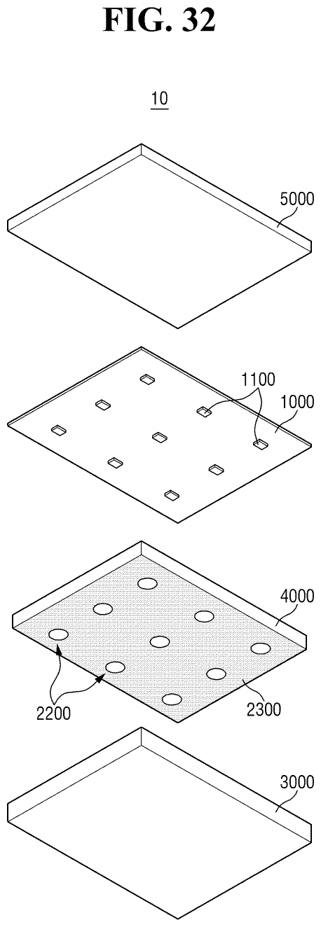

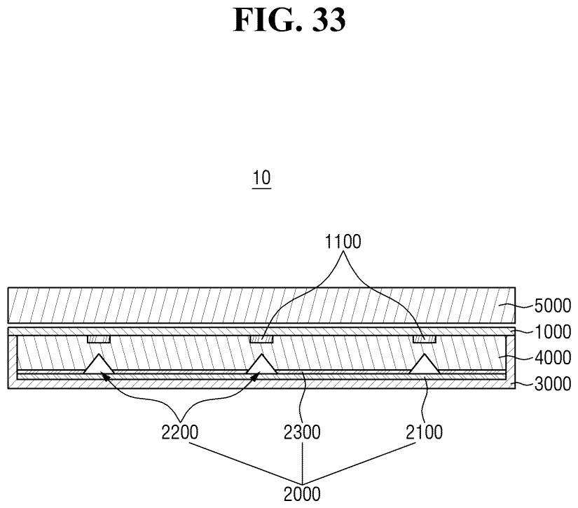

FIG. 32 is an exploded perspective view illustrating a light-emitting module according to a fifth embodiment of the present disclosure, and FIG. 33 is a cross-sectional view illustrating the light-emitting module according to the fifth embodiment of the present disclosure.

Referring to FIGS. 32 and 33, a light-emitting module 10 according to the fifth embodiment of the present disclosure, like its counterparts of the previous embodiments, may include a substrate 1000 and a deflection part 2000. Components performing the same functions as those in the previous embodiments are assigned the same reference numerals, and detailed descriptions thereof will be omitted.

In the fifth embodiment of the present disclosure, the deflection part 2000 may include a reflective layer 2100 and a plurality of diffusion elements 2200, and may also include a reflective surface 2300 formed on at least a portion of a rear surface 4200 of a transmissive material 4000. The reflective surface 2300 may be formed by depositing or coating a high-reflectivity material, such as aluminum or chromium, on the rear surface 4200 of the transmissive material 4000, or by applying a high-reflectivity paint, such as white paint.

In some embodiments where the reflective surface 2300 is formed on the rear surface 4200 of the transmissive material 4000, the reflective layer 2100 formed on a holder 3000 may be omitted. However, to maximize light reflection efficiency, the reflective layer 2100 may be formed on the holder 3000 even when the reflective surface 2300 is formed on the rear surface 4200 of the transmissive material 4000. The fifth embodiment of the present disclosure provides an example where both the reflective layer 2100 and the reflective surface 2300 are formed together.

In other words, when the light emitted in the first direction from a plurality of first light sources 1100 passes through the reflective surface 2300 formed on the rear surface 4200 of the transmissive material 4000, even a small amount of light that passes through the reflective surface 2300 may cause light loss. By forming the reflective layer 2100 on the holder 3000, the light that passes through the reflective surface 2300 can be redirected toward the substrate 1000, thereby improving light efficiency.

In the fifth embodiment of the present disclosure, the rear surface 4200 of the transmissive material 4000 may be divided into a first region where the plurality of diffusion elements 2200 are formed and a second region where no diffusion elements 2200 are formed. The reflective surface 2300 may be formed in the second region, but the present disclosure is not limited thereto. Alternatively, the reflective surface 2300 may be formed over the entire rear surface 4200 of the transmissive material 4000.

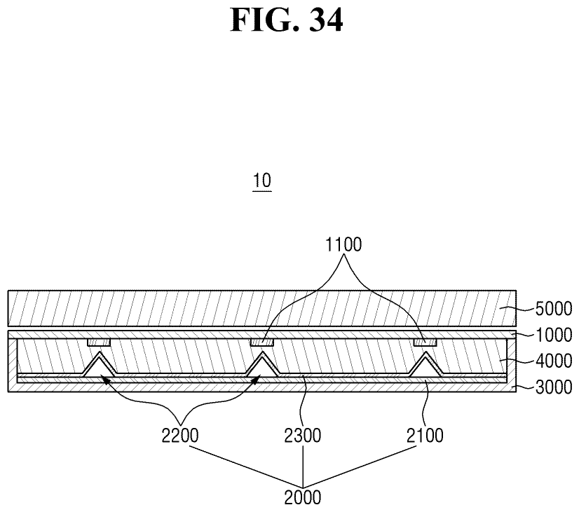

FIG. 34 is a cross-sectional view illustrating a light-emitting module according to a sixth embodiment of the present disclosure.

Referring to FIG. 34, in a light-emitting module 10 according to the sixth embodiment of the present disclosure, unlike in the fifth embodiment, a reflective surface 2300 may be formed over an entire rear surface 4200 of a transmissive material 4000. In this case, the reflective surface 2300 may be formed not only in the second region where no diffusion elements 2200 are formed, but also in the first region where the plurality of diffusion elements 2200 are formed.

As described with reference to FIGS. 32 through 34, the reflective surface 2300 may be formed on at least a portion of the rear surface 4200 of the transmissive material 4000 to prevent smudges due to brightness inconsistencies in the illuminated image formed by the light-emitting module 10, as viewed from the outside, when some portions of the rear surface 4200 of the transmissive material 4000 are spaced at different intervals from the opposing surface of the holder 3000 facing the substrate 1000.

In other words, if the reflective surface 2300 is not formed on the rear surface 4200 of the transmissive material 4000, the thickness of the air layer existing between the rear surface 4200 of the transmissive material 4000 and the reflective layer 2100 on the holder 3000 may vary, depending on the spacing. This may result in differences in the degree of light diffusion, causing smudges due to non-uniform brightness in the illuminated image formed by the light emitted from the light-emitting module 10. Conversely, when the reflective surface 2300 is formed on at least a portion of the rear surface 4200 of the transmissive material 4000, the illuminated image can have more uniform brightness, regardless of whether portions of the rear surface 4200 of the transmissive material 4000 are spaced with non-uniform gaps from the opposing surface of the holder 3000 that faces the substrate 1000. Consequently, smudges can be prevented.

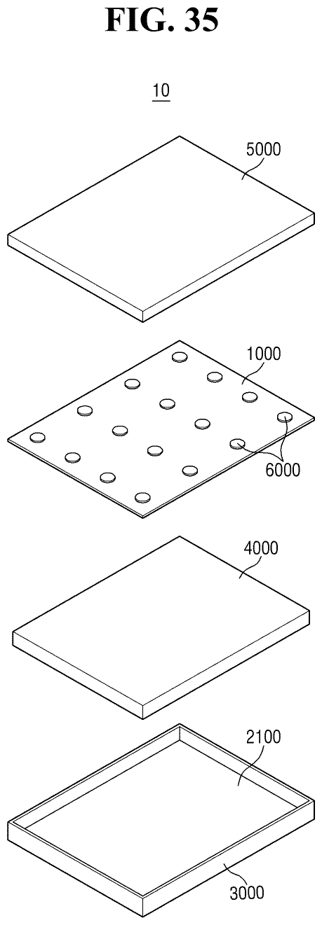

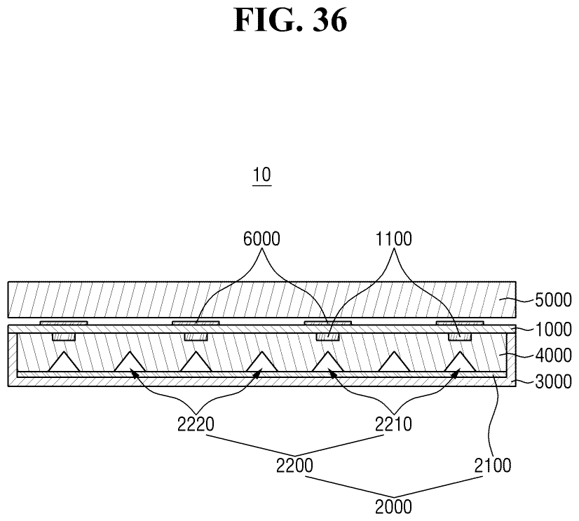

FIG. 35 is an exploded perspective view illustrating a light-emitting module according to a seventh embodiment of the present disclosure, and FIG. 36 is a cross-sectional view illustrating the light-emitting module according to the seventh embodiment. FIG. 36 corresponds to an example where a plurality of diffusion elements 2200 include first diffusion patterns 2210 and second diffusion patterns 2220, as described earlier with reference to FIGS. 26 through 28.

Referring to FIGS. 35 and 36, a light-emitting module 10 according to the seventh embodiment of the present disclosure, like its counterparts of the previous embodiments, may include a substrate 1000 and a deflection part 2000. Components performing the same functions as those in the previous embodiments are assigned the same reference numerals, and detailed descriptions thereof will be omitted.

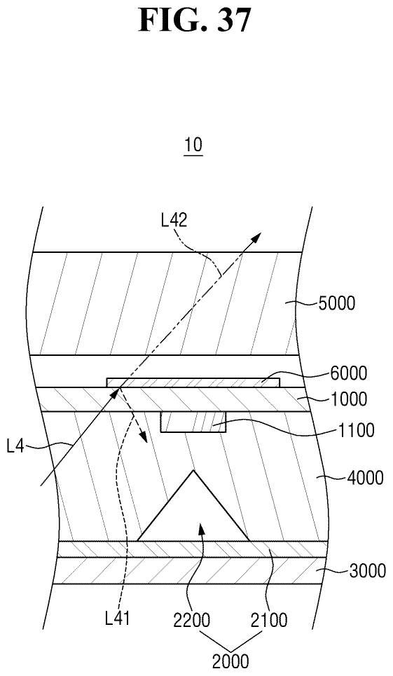

In the seventh embodiment of the present disclosure, a plurality of first light sources 1100 may overlap with at least portions of a plurality of light diffusion layers 6000, respectively. As illustrated in FIG. 37, the light diffusion layers 6000 may each reflect light L41, which is a portion of light L4 deflected into the second direction by a reflective layer 2100 or the plurality of diffusion elements 2200, while transmitting therethrough light L42, which is another portion of the light L4. The light L41 reflected by the light diffusion layers 6000 may again be reflected by the reflective layer 2100 and/or the plurality of diffusion elements 2200, ensuring that the light emitted from the light-emitting module 10 generally has more uniform brightness.

FIG. 37 illustrates an example where the plurality of diffusion elements 2200 are first diffusion patterns 2210 that are formed to correspond to the plurality of first light sources 1100.

The light diffusion layers 6000 may each be formed as a coating layer with white paint that reflects a portion of light deflected toward the vicinity of the corresponding first light source 1100 and transmits therethrough another portion of the light. Alternatively, the light diffusion layers 6000 may each be formed and attached to the substrate 1000 as one or more separate films.

The seventh embodiment describes an example where the light diffusion layers 6000 are formed on the front surface of the substrate 1000. However, the present disclosure is not limited thereto. Alternatively, the light diffusion layers 6000 may be formed on at least one of the front or rear surface of the substrate 1000. Yet alternatively, the light diffusion layers 6000 may be formed on at least one of the front or rear surface of another light-transmissive component, such as a diffusion sheet 1000a or a cover 5000.

The light diffusion layers 6000 may preferably have a size 1 to 6 times that of the first light sources 1100. If the light diffusion layers 6000 are smaller than the first light sources 1100, diffusion may be ineffective. Conversely, if the light diffusion layers 6000 are more than 6 times larger than the first light sources 1100, light efficiency may be reduced.

Meanwhile, as illustrated in FIG. 37, the light diffusion layers 6000 may reflect the light L41 and transmit the light L42 among the light L4 deflected in the second direction, which ensures more uniform brightness of the light emitted from the light-emitting module 10. Additionally, the light diffusion layers 6000 may function to improve dark shadow regions caused by the rear surfaces of the first light sources 1100 when viewed from the front of the substrate 1000.

In other words, when the first light sources 1100 are installed on the rear surface of the substrate 1000, the emission surfaces of the first light source 1100 face backward, causing dark shadow regions to be formed due to the rear surfaces of the first light sources 1100, when viewed from the front of the substrate 1000. In the seventh embodiment, the light diffusion layers 6000 with a white color may improve the dark shadow regions potentially caused by the rear surfaces of the first light sources 1100.

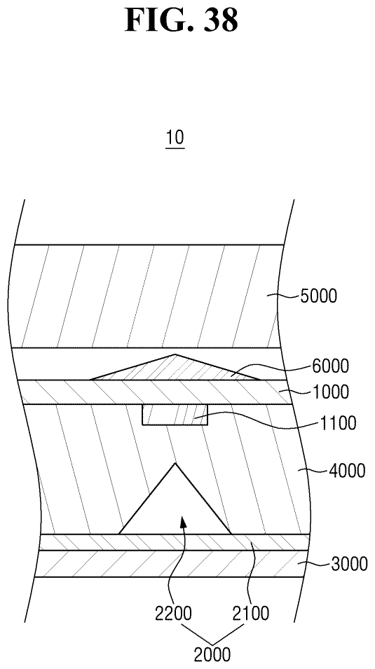

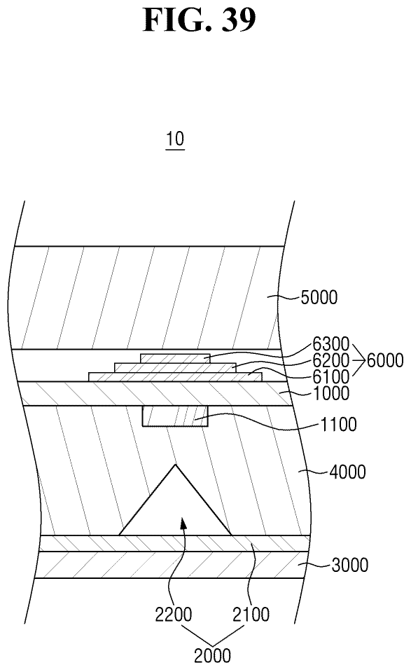

The light diffusion layers 6000 may be formed to have a greater thickness near the centers of the first light sources 1100, as illustrated in FIGS. 38 and 39. When the first light sources 1100 are installed on the rear surface of the substrate 1000, the emission surfaces of the first light sources 1100 may face backward, not forward, and as a result, dark shadow regions may be formed by the rear surfaces of the first light sources 1100 when viewed from the front of the substrate 1000. By forming the light diffusion layers 6000 to be thicker near the centers of the first light sources 1100, relatively darker patterns caused by the rear surfaces of the first light sources 1100 can be prevented from being visible from the front of the substrate 1000.

The light diffusion layers 6000 may be formed to be thinner going away from the centers of the first light sources 1100. If the light diffusion layers 6000 overall have a thickness corresponding to the centers of the first light sources 1100, light diffusion efficiency may decrease, reducing light efficiency.

FIG. 38 illustrates an example where the light diffusion layers 6000 are each formed as a single layer with a tapering thickness from the center toward the edges. FIG. 39 illustrates an example where the light diffusion layers 6000 are each composed of a plurality of stacked layers 6100, 6200, and 6300, among which, an upper layer is formed to have a smaller dimension in at least one direction from the center of the corresponding first light source 1100, so that it becomes smaller in size. Accordingly, the light diffusion layers 6000 may become thicker going closer to the centers of the first light sources 1100.

As described with reference to FIGS. 38 and 39, the light diffusion layers 6000 may be formed to be thicker near the centers of the first light sources 1100, considering that relatively darker patterns tend to be formed closer to the centers of the first light sources 1100.

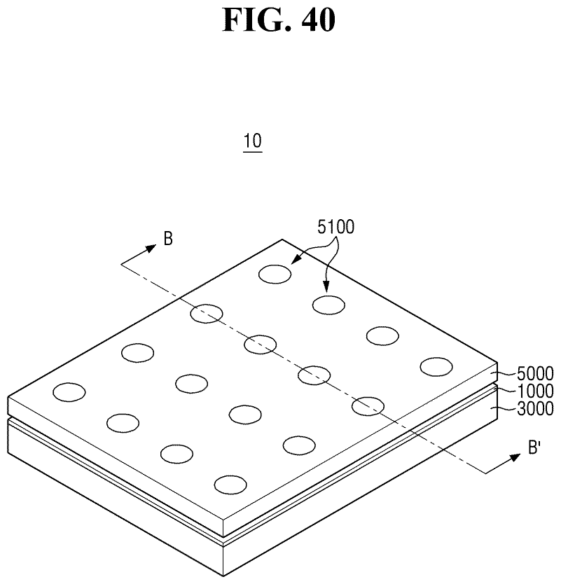

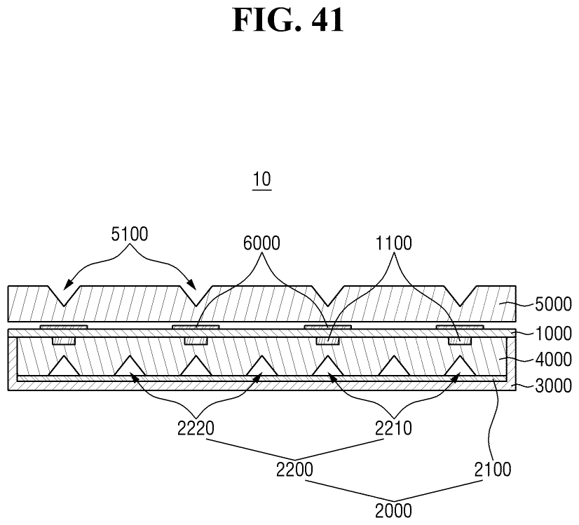

FIG. 40 is a perspective view illustrating a light-emitting module according to an eighth embodiment of the present disclosure, and FIG. 41 is a cross-sectional view taken along line B-B′of FIG. 40, illustrating an example where a plurality of diffusion elements 2200 include first diffusion patterns 2210 and second diffusion patterns 2220, as described earlier with reference to FIGS. 26 through 28.

Referring to FIGS. 40 and 41, a light-emitting module 10 according to the eighth embodiment of the present disclosure, like its counterparts of the previous embodiments, may include a substrate 1000 and a deflection part 2000. Components performing the same functions as those in the previous embodiments are assigned the same reference numerals, and detailed descriptions thereof will be omitted.

In the eighth embodiment of the present disclosure, a cover 5000 may be formed with a plurality of optical elements 5100 having a concave shape at positions corresponding to a plurality of first light sources 1100. The plurality of optical elements 5100 may function to improve dark shadow regions potentially caused due to the plurality of first light sources 1100 installed on the rear surface of the substrate 1000.

The plurality of optical elements 5100 may be formed on at least one of the front or rear surface of the cover 5000. When the light emitted in the first direction from the plurality of first light sources 1100 is deflected into the second direction by the deflection part 2000 and passes through the substrate 1000, the plurality of optical elements 5100 may redirect some of the light transmitted through the substrate 1000 to increase the brightness in the area corresponding to each of the plurality of first light sources 1100, thereby eliminating or reducing the dark shadow regions potentially caused by the plurality of first light sources 1100, together with the light diffusion layers 6000 of the seventh embodiment.

FIGS. 40 and 41 illustrate an example where the light diffusion layers 6000 are formed on the front surface of the substrate 1000 at positions corresponding to the plurality of first light sources 1100, and the plurality of optical elements 5100 having a concave shape are formed on the front surface of the cover 5000 at positions corresponding to the plurality of first light sources 1100. However, the present disclosure is not limited thereto. Alternatively, the plurality of optical elements 5100 may be formed on at least one of the front or rear surface of the cover 5000.

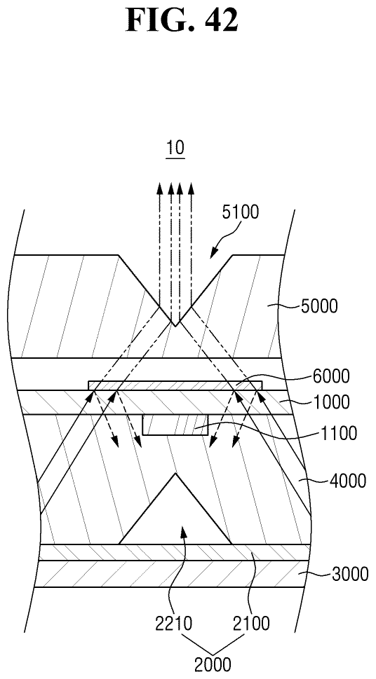

As illustrated in FIG. 42, the plurality of optical elements 5100 may function to redirect the light that passes through the light diffusion layers 6000. As a result, when viewed from the front of the substrate 1000, the light redirected by the plurality of optical elements 5100 can prevent the formation of dark shadow regions due to the light deflected by the plurality of first light sources 1100.

In the eighth embodiment of the present disclosure, an example is provided where the plurality of optical elements 5100 are configured to scatter some of the light transmitted through the substrate 1000, thereby improving the dark shadow regions caused by the plurality of first light sources 1100 when viewed from the front of the substrate 1000. However, the present disclosure is not limited thereto. The plurality of optical elements 5100 may diffuse, scatter, and/or converge some of the light transmitted through the substrate 1000 for deflection, thereby improving the dark shadow regions caused by the plurality of first light sources 1100 depending on the viewing angle.

In the eighth embodiment described above, an example is provided where the plurality of optical elements 5100 are formed alongside the light diffusion layers 6000 to improve the dark shadow regions caused by installing the plurality of first light sources 1100 on the rear surface of the substrate 1000. However, the present disclosure is not limited thereto. The dark shadow regions may also be improved by either the light diffusion layers 6000 or the plurality of optical elements 5100.

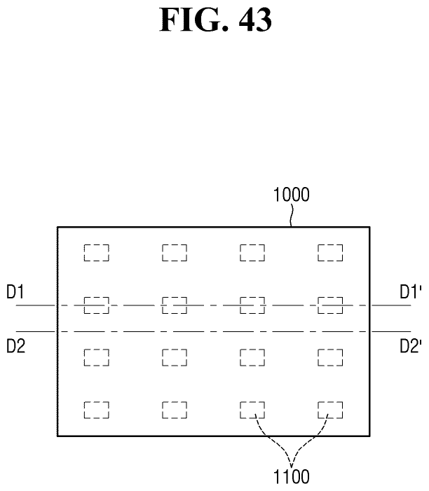

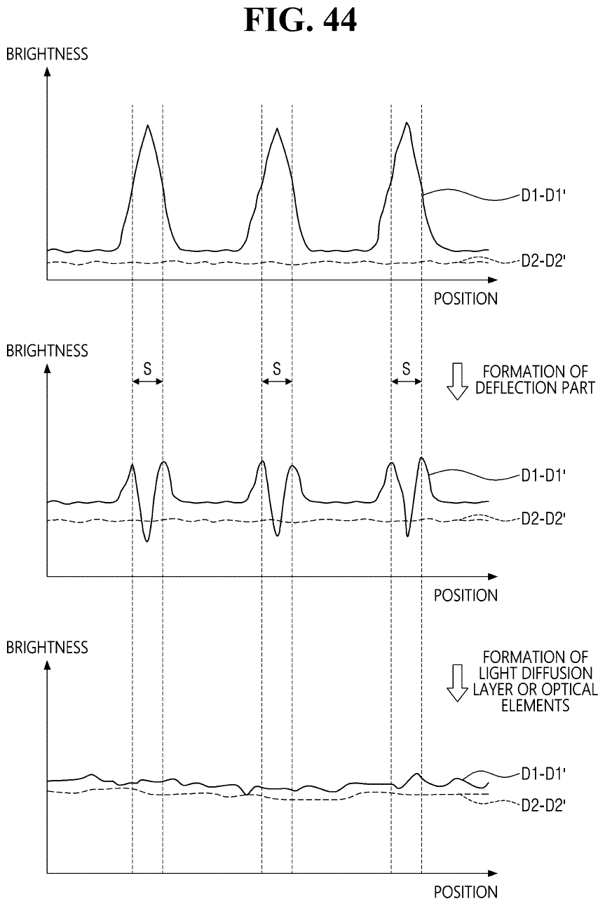

FIG. 43 is a schematic diagram illustrating a line along which the brightness of a light-emitting module according to an embodiment of the present disclosure is measured, and FIG. 44 is a schematic diagram illustrating the brightness distribution of the light-emitting module according to an embodiment of the present disclosure. Line D1-D1′ may be understood as a line that passes through a plurality of first light sources 1100 in one direction, and line D2-D2′ may be understood as a line that passes between adjacent first light sources 1100.

Referring to FIGS. 43 and 44, when a plurality of first light sources 1100 are installed on the front surface of a substrate 1000, a deflection part 2000 described in the previous embodiments may not be formed. Thus, as illustrated in the top panel of FIG. 44, the brightness profile became relatively high in sections S, which corresponded to the emission surfaces of the plurality of first light sources 1100, thereby creating hotspots and insufficient light mixing. As a result, the brightness between adjacent first light sources 1100 became relatively low. Conversely, when deflection part 2000, which included a reflective layer 2100, a plurality of diffusion elements 2200, and a reflective surface 2300, was formed, the light emitted from the plurality of first light sources 1100 installed on the rear surface of the substrate 1000 was able to be diffused by the deflection part 2000, including the reflective layer 2100 and the plurality of diffusion elements 2200, as illustrated in the middle panel of FIG. 44. As a result, the brightness along lines D1-D1′ and D2-D2′ increased, while the brightness difference decreased relatively. These results improved overall brightness uniformity while ensuring sufficient brightness for implementing surface light emission.

At this time, as shown in the middle panel of FIG. 44, the brightness of the sections S corresponding to the plurality of first light sources 1100 decreased since the plurality of first light sources 1100 were installed on the rear surface of the substrate 1000, resulting in dark shadow regions when viewed from the front of the substrate 1000. However, when either or both of the aforementioned light diffusion layers 6000 or optical elements 5100 were formed, as illustrated in the bottom panel of FIG. 44, the dark shadow regions caused by installing the plurality of first light sources 1100 on the rear surface of the substrate 1000 were improved. As a result, the brightness difference on lines D1-D1′ line and D2-D2′ decreased overall, enabling the light-emitting module 10 of the present disclosure to implement a surface light source with a significantly improved uniformity of brightness.

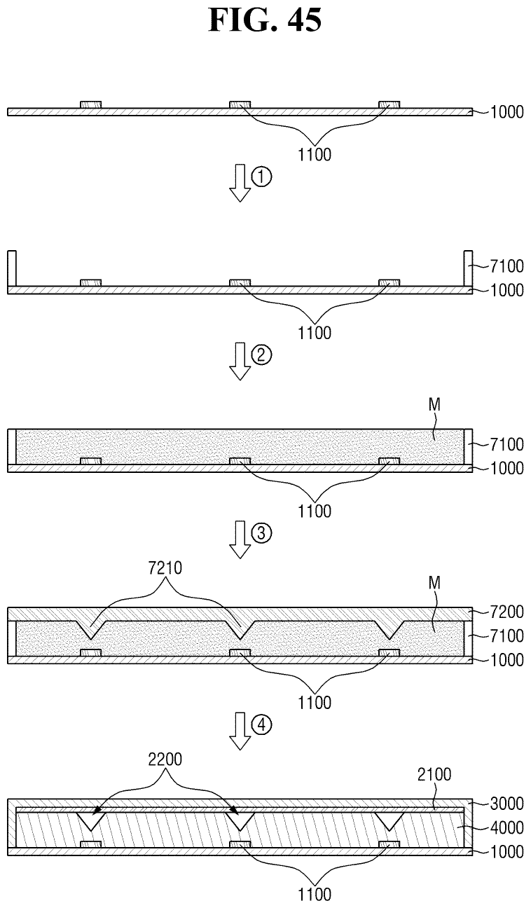

FIG. 45 is a schematic diagram illustrating a manufacturing process of a light-emitting module according to an embodiment of the present disclosure, particularly, an example where a deflection part 2000 includes both a reflective layer 2100 and diffusion elements 2200, and where a cover 5000 is omitted for illustration purposes.

Referring to FIG. 45, the manufacturing process of the light-emitting module 10 according to an embodiment of the present disclosure may involve: positioning a mold 7100 for forming a transmissive material 4000 at the rear of a substrate 1000 with a plurality of first light sources 1100 installed on its rear surface (\textcircled{1}; note that the substrate 1000 is shown inverted in the figure); and filling a molding material M for forming the transmissive material 4000 into the internal space of the mold 7100 \textcircled{2}).

After filling the molding material M, a mold cover 7200 including protrusions 7210 may be placed on the mold 7100 to form a plurality of diffusion elements 2200, and the transmissive material 4000 with the plurality of diffusion elements 2200 may be formed by curing the molding material M \textcircled{3}).

After molding the transmissive material 4000, the mold cover 7200 may be removed, and a holder 3000, on which a reflective layer 2100 is formed on at least a portion of the opposing surface facing the substrate 1000, may be disposed \textcircled{4}).

In FIG. 45, an example is provided where the transmissive material 4000 is formed by curing the molding material filled into the rear of the substrate 1000. However, this is merely exemplary for aiding understanding of the present disclosure, and the transmissive material 4000 may also be formed through a separate process and then be combined to the rear of the substrate 1000.

In the aforementioned embodiments, an example is provided where a transparent PCB is used as the substrate 1000, but the present disclosure is not limited thereto. Alternatively, the substrate 1000 may be implemented as an opaque PCB, which includes portions opened to allow the transmission of the light deflected by the deflection part 2000.

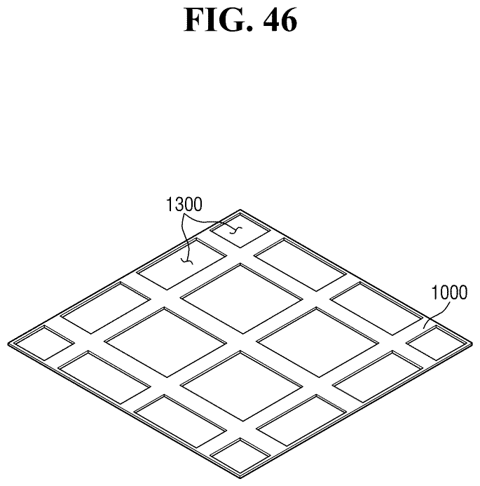

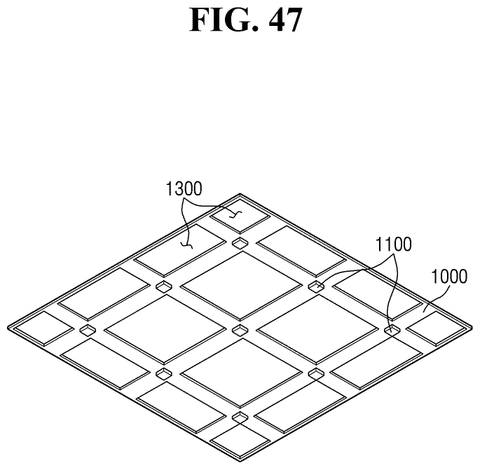

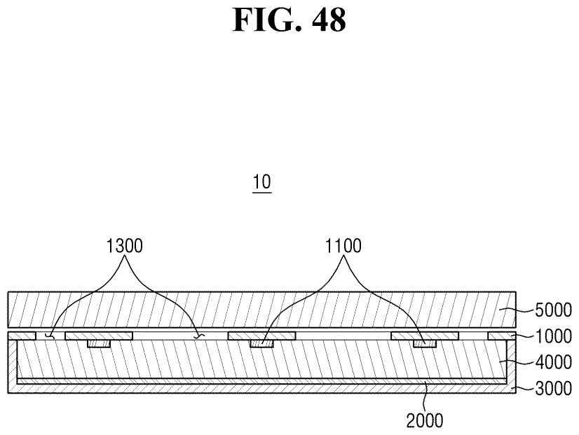

FIGS. 46 and 47 are perspective views illustrating a substrate with such openings according to an embodiment of the present disclosure, and FIG. 48 is a cross-sectional view illustrating a light-emitting module including the substrate with openings, particularly, an example where a plurality of diffusion elements 2200 are omitted, and a reflective layer 2100 is formed as a deflection part 2000.

Referring to FIGS. 46 through 48, even when the substrate 1000 is implemented as an opaque PCB formed of an opaque material such as FR4 or metal, a plurality of openings 1300 may be formed between adjacent first light sources 1100. In this case, at least some of the light deflected in the second direction by a deflection part 2000 may pass through the plurality of openings 1300 formed in the substrate 1000 and may be emitted to the outside of the light-emitting module 10 of the present disclosure, enabling the light-emitting module 10 of the present disclosure to implement surface light emission, as in the previous embodiments.

Here, an opaque PCB may be used as the substrate 1000 as it allows for the application of high current and has excellent heat resistance compared to a transparent PCB. When the light-emitting module 10 of the present disclosure requires high current application and high heat resistance, the plurality of openings 1300 may be formed in the substrate 1000 while using an opaque PCB as the substrate 1000 in instead of a transparent PCB, to allow the light deflected by the deflection part 2000 to proceed forward.

At this time, in a case where the substrate 1000 is implemented as an opaque PCB, certain portions may exist in the substrate 1000 that do not transmit light therethrough due to the installation of a plurality of first light sources 1100 and wiring, which may create unnecessary dark shadow regions. To prevent these dark spots, a diffusion sheet may be disposed on at least one of the front or rear surface of the substrate 1000 to diffuse the light that passes through the plurality of openings 1300, thereby avoiding the formation of unnecessary dark shadow regions.

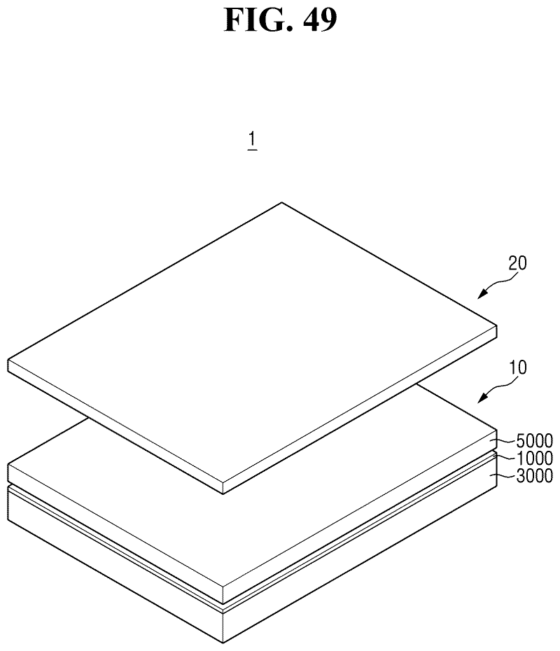

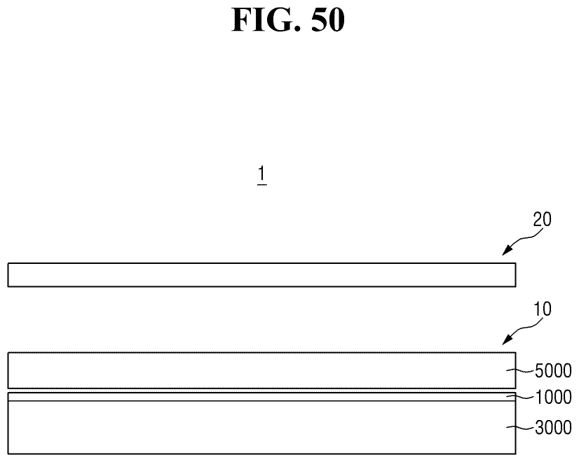

FIG. 49 is a perspective view illustrating a vehicle lamp according to an embodiment of the present disclosure, and FIG. 50 is a side view illustrating the vehicle lamp according to an embodiment of the present disclosure.

Referring to FIGS. 49 and 50, a vehicle lamp 1 according to an embodiment of the present disclosure may include a light-emitting module 10 and a diffusion lens 20. The light-emitting module 10 may be understood as the light-emitting module 10 of any one of the aforementioned embodiments or any combinations thereof.

The diffusion lens 20 may include a surface treated by etching or a diffusion pattern formed on at least one of the incident or exit surface to diffuse the light emitted from the light-emitting module 10 through the cover 5000 and directed to the exterior of the vehicle. This configuration may enable the implementation of a surface light source capable of forming an illuminated image with substantially uniform brightness when viewed from outside the vehicle.

Here, the diffusion lens 20 may function not only to diffuse light, but also to protect the light-emitting module 10 from external impacts.

As described above, the light-emitting module and the vehicle lamp including the same according to the present disclosure can enable a plurality of first light sources 1100 to be installed on the rear surface of the substrate 1000. The light emitted in the first direction from the plurality of first light sources 1100 may be deflected in the second direction by the deflection part 2000 disposed behind the substrate 1000 and may be emitted to outside through the substrate 1000. Accordingly, the gap required for sufficient light mixing can be reduced, enabling miniaturization. At the same time, the light emitted from the plurality of first light sources 1100 can be more effectively diffused, improving brightness uniformity in the implemented surface light emission.

Those skilled in the art to which the present disclosure pertains will understand that the present disclosure may be implemented in other specific forms without changing the technical spirit or essential features thereof. Therefore, the embodiments described above are merely illustrative in all aspects and not limiting. The scope of the present disclosure is defined by the appended claims rather than the above detailed description, and it should be construed that all changes or modifications derived from the meaning, scope, and equivalents of the claims fall within the scope of the present disclosure.

What is claimed is:

1. A light-emitting module comprising:
a substrate formed of a transparent material;
at least one light source installed on a rear surface of the substrate to emit light in a first direction; and
a deflection part disposed behind the substrate to deflect the light emitted in the first direction in a second direction,
wherein the deflection part includes a reflective surface formed on at least a portion of a rear surface of a transmissive material disposed between the substrate and a holder disposed behind the substrate to support the substrate.

2. The light-emitting module of claim 1, wherein the deflection part further includes at least one diffusion element formed on the rear surface of the transmissive material to diffuse the light emitted in the first direction so that at least a portion of the light is deflected in the second direction via refraction and/or reflection.

3. The light-emitting module of claim 2, wherein the rear surface of the transmissive material includes a first region where the at least one diffusion element is formed and a second region where no diffusion element is formed, and
wherein the reflective surface is formed in at least one of the first region or the second region.

4. The light-emitting module of claim 1, wherein the reflective surface is formed by depositing or coating a material capable of reflecting light.

5. The light-emitting module of claim 1, wherein the reflective surface is formed by applying a color capable of reflecting light.

6. The light-emitting module of claim 1, wherein the deflection part further includes a reflective layer formed on at least a portion of an opposing surface of the holder that faces the substrate.

7. The light-emitting module of claim 1, further comprising:
at least one light diffusion layer disposed to overlap with the at least one light source to diffuse light that passes near the at least one light source.

8. The light-emitting module of claim 7, wherein the at least one light diffusion layer transmits a portion of the deflected light therethrough while reflecting another portion of the deflected light.

9. The light-emitting module of claim 7, wherein the at least one light diffusion layer is formed to have a greater thickness proximate to a center of the at least one light source.

10. The light-emitting module of claim 7, wherein the at least one light diffusion layer is formed by stacking a plurality of layers, and
wherein an upper layer disposed in a stacking direction of the plurality of layers is formed to have a smaller dimension in at least one direction relative to a center of the at least one light source.

11. The light-emitting module of claim 7, wherein the at least one light diffusion layer is formed on one surface of at least one of the substrate or a cover disposed in front of the substrate to allow at least a portion of the light deflected by the deflection part to pass therethrough.

12. The light-emitting module of claim 1, further comprising:
a cover disposed in front of the substrate to allow at least a portion of the light deflected by the deflection part to pass therethrough, the cover having at least one optical element formed at a position corresponding to the at least one light source to deflect the light that passes through the substrate.

13. A vehicle lamp comprising:
a light-emitting module including at least one light source; and
a diffusion lens disposed in front of the light-emitting module to diffuse light emitted from the light-emitting module,
wherein a direction in which the light is emitted from the light-emitting module is different from a direction in which the light is emitted from the at least one light source.

14. The vehicle lamp of claim 13, wherein the light-emitting module includes:
a substrate having the at least one light source installed on a rear surface thereof;
a holder disposed behind the substrate to support the substrate;
a transmissive material disposed between the substrate and the holder; and
a cover disposed in front of the substrate and coupled to the holder to form a space for accommodating the substrate and the transmissive material therein, and
wherein the cover includes at least one optical element formed at a position corresponding to the at least one light source to deflect at least a portion of the light transmitted through the substrate.

15. The vehicle lamp of claim 14, wherein the transmissive material includes at least one diffusion element formed on a rear surface of the transmissive material to deflect the light emitted in a first direction from the at least one light source in a second direction, and
wherein a reflective surface is formed on at least a portion of the rear surface of the transmissive material to reflect at least a portion of the light emitted in the first direction from the at least one light source.

16. The vehicle lamp of claim 15, wherein the at least one diffusion element refracts and/or reflects at least a portion of the light emitted in the first direction in the second direction depending on an angle of incidence of the light emitted in the first direction.

17. The vehicle lamp of claim 14, wherein the light-emitting module further comprises:
a reflective layer formed on at least a portion of an opposing surface of the holder that faces the substrate.

18. The vehicle lamp of claim 13, further comprising:
at least one light diffusion layer disposed to overlap with the at least one light source,
wherein the at least one light diffusion layer reflects a portion of light that passes near the at least one light source and transmits another portion of the light therethrough.

19. The vehicle lamp of claim 18, wherein the at least one light diffusion layer is formed to have a greater thickness proximate to a center of the at least one light source.

20. The vehicle lamp of claim 18, wherein the at least one light diffusion layer includes a plurality of stacked layers, and
wherein an upper layer disposed in a stacking direction of the plurality of layers is formed to have a smaller dimension in at least one direction relative to a center of the at least one light source.
